(19) United States
(12) Patent Application Publication
(10) Pub. No.: US 2009/0233836 A1
(43) Pub. Date: Sep. 17, 2009

(54) Perfuming method and product

(75) Inventors: Jean-Francois Bodet, Waterloo (BE); Giovanni Carrara, Montesilvane (IT); Alex Haejoon Chung, West Chester, OH (US); Daniel Dale Ditullio, JR., Hamilton, OH (US); Robert Richard Dykstra, West Chester, OH (US); Kristin Marie Finley, Milford, OH (US); Renae Dianna Fossum, Middletown, OH (US); Marcia Mary Ketcha, Cincinnati, OH (US); Zaiyou Liu, West Chester, OH (US); George Kavin Morgan, III, Hamilton, OH (US); Philip Kyle Vinson, Fairfield, OH (US)

Correspondence Address: THE PROCTER & GAMBLE COMPANY;Global Legal Department - IP, Sycamore Building - 4th Floor, 299 East Sixth Street, CINCINNATI, OH, 45202, US

(73) Assignee: The Procter & Gamble Company, Cincinnati, OH (US)

(21) Appl. No.: 12/075,381

(22) Filed: Mar. 11, 2008

(51) Int. Cl. C11D 17/00

(52) U.S. Cl. 510/293

(57) ABSTRACT

A fabric enhancer product comprising (a) a package comprising (1) a container; and (2) a closure; (b) a fabric enhancer comprising a material copourable from the package with the fabric enhancer, wherein the material is selected from: (1) a fabric enhancer-copourable perfume composition; (2) a fabric care additive; and (3) any combination thereof; (c) a headspace; and (d) a fabric enhancer-non-copourable perfume composition; wherein the pH of the fabric enhancer is less than 7.

### BACKGROUND OF THE INVENTION

Fabric enhancers are well-known as a distinct consumer product category which has unique challenges associated with formulation and packaging. Such products commonly contain perfume, and are sold in packages such as bottles, from which the product is poured through a relatively wide-necked pouring spout. Consumers generally desire a clean and fresh odor whenever they open the package and smell the product, after the completing of the washing and/or drying cycles, and on laundered clothing that has been stored for a period of time.

Perfumed fabric enhancers continue to have many shortcomings. For example, perfumes are complex mixtures of costly ingredients and are often chemically reactive or incompatible with fabric enhancers. This can adversely affect both the perfumes and the materials with which they interact. Further, these compatibility problems can be much greater than those encountered in the case of technically simpler cleaning products such as toilet bowl cleaners, automatic dishwashing products, shampoos or dishwashing agents. Shampoos and hand dishwashing products, in particular, are sold in packages having restricted orifices through which the products are squeezed, and therefore do not have a large opening through which a consumer can smell the product.

Fabric enhancer ingredients may contain certain components with undesirable odor and further, fabric enhancers contain a challenging array of adjuncts that make perfume stabilization difficult. Moreover a major fraction of the costly perfumes can be lost “down the drain” when the product is used to treat clothes in an automatic laundry washing machine. Additionally, the scent of the perfume on the washed or treated substrate should be long lasting. Finally, the fabric enhancer must have an overall perfume character that is acceptable to consumers.

What is therefore needed are fabric enhancers that provide improved perfume impression on opening the package, improved efficiency of use of perfumery ingredients, better compatibility of perfume and fabric enhancer, better perfume impression at various points during use of the product and on the laundered textiles thereafter, the ability to incorporate a range of modern performance adjuncts, and the ability to effectively control any malodor of commonly available fabric enhancer materials.

These needs must be met in a manner consistent with satisfying consumers with respect to the olfactory character of perfumes that they seek in the specific context of fabric laundering, and without incurring manufacturing complexity increase as the components of package and fabric enhancer are assembled into the product that is to be sold.

### SUMMARY OF THE INVENTION

In one aspect, the present invention includes a fabric enhancer product comprising (a) a package comprising (1) a container; and (2) a closure; (b) a fabric enhancer comprising a material copourable from the package with the fabric enhancer, wherein the material is selected from: (1) a fabric enhancer-copourable perfume composition; (2) a fabric care additive; and (3) any combination thereof; (c) a headspace; and (d) a fabric enhancer-non-copourable perfume composition;

wherein the pH of the fabric enhancer is less than about 7.

### DETAILED DESCRIPTION OF THE INVENTION

One aspect of the invention relates to a fabric enhancer product comprising (a) a package comprising (1) a container; and (2) a closure; (b) a fabric enhancer comprising at least one fabric care additive and a material copourable from the package with the fabric enhancer, wherein the material is selected from: (1) a fabric enhancer-copourable perfume composition; (2) a fabric care additive; (3) perfume microcapsules; and (4) any combination thereof; (c) a headspace; and (d) a fabric enhancer-non-copourable perfume composition.

Without wishing to be bound by theory, it is believed that the present invention delivers perfume during at least four significant points to the consumer while maximizing the efficiency of the perfumes contained within the container. The consumer is presented with perfume when opening the container at the first moment of truth. The consumer is presented with perfume after the completion of the laundry cycle at the second moment of truth. Finally, the consumer is presented with perfume after the storage of clothing, as well as during the wear of clothing at the third moment of truth.

There is a need by consumers who desire second and third moment of truth experience, for example, scent out of the dryer and dry fabric odor. Some consumers, however, desire the dry fabric odor to last up to 1 week, but not much longer. For consumer who want to control such initial dry fabric odor intensity, we have surprisingly found that such a scent experience can be achieved by formulating the fabric enhancer with a low, even zero, free or neat perfume level if the perfume microcapsule and amine-assisted delivery systems concentrations are selected such that the polymeric amine to free perfume ratio is about greater than 0.4 and about less than 25, even about greater than 0.4 and less than 5. In another embodiment, such fabric enhancer compositions also include a fabric enhancer-non-copourable perfume.

There is also a need by consumers who desire the third moment of truth experience to last for longer periods, for example, their dry fabric to have greater scent intensity for more than 1 week. For consumer who desire to obtain dry fabric odor intensity for even longer periods of time, we have surprisingly found that such a scent experience can be achieved by formulating the fabric enhancer with microcapsule and polymeric amine and free perfume. Surprisingly, increasing polymeric amine levels much beyond 1% leads to a reduction in dry fabric odor performance. More surprisingly, it was discovered that a polymeric amine to free perfume ratio of greater than 0.030 and less than 0.40 results in the desired dry fabric longevity experience.

Without wishing to be bound by theory, the selected ratio of polymeric amine to free perfume may provide the proper balance between perfume deposition and perfume release. Ratios that are outside the current invention may lead to greater perfume suppression and untimely release.

It has also been surprisingly found that the ratio of total polymer concentration, of all polymers with a molecular weight greater than 1000 Daltons in the fabric enhancer-copourable perfume composition, to perfume in the fabric enhancer-copourable perfume composition is an important factor for achieving the consumer desired perfume scent longevity. In one embodiment, the total polymer to free perfume ratio is from about 0.02 to about 3.0%, in another embodiment from about 0.10% to about 2.0%, in another embodiment from about 0.20 to about 1.0%.

### Package

One aspect of the invention relates to a fabric enhancer product comprising a package comprising (1) a container, typically a bottle, and (2) a closure. In certain embodiments, the package further comprises (3) a transition component, such as a transition collar. Suitable packages may be found in U.S. Pat. No. 4,550,862, U.S. Pat. No. 5,108,009, U.S. Pat. No. 6,398,076, and U.S. Pat. No. 6,659,310. In certain embodiments when the fabric enhancer comprises two or more liquids which are, for example, immiscible, it may be advantageous to use a package as described in U.S. Pat. No. 6,644,511.

In certain embodiments, it may be advantageous to include a vented closure device. Suitable vented closure devices are described in U.S. Pat. Nos. 6,601,740 and 6,874,656.

In certain embodiments, it may be advantageous to include a drain-back snap-on pour spout closure to equip the container with child safety features. In certain such embodiments, the drain back pour spout fitment has a snap fit structure overlaying a container neck finish and may be secured thereto with adhesives. The snap fit structure includes an outer annular skirt with internal, radial inwardly facing beads engaging a radial outwardly facing surface of the container finish. Spaced from the outer annular skirt by a horizontal upper flange, the spout fitment includes an inner annular skirt with internal threads on the fitment to receive an externally threaded closure. The closure has a plug seal above the threads engaging the upper flange of the fitment and a radial outwardly facing latch engaging a radial inwardly facing interfering projection on the fitment forming a child safety feature for the fitment closure. An example of such a closure may be found in U.S. Pat. No. 6,923,341.

Any suitable structural plastic may be used to make the packages. Such structural plastics include, but are not limited to, polyethylene, polypropylene, polyethylene terephthalate, and the like. In certain embodiments, the structural plastic of the package may be transparent as described in U.S. Pat. No. 6,756,350. In certain alternative embodiments, the structural plastic may be opaque, or may incorporate structural plastics having differing opacity, e.g., a transparent stripe through which the level of product in the package can be seen, while the remainder of the package is opaque.

In certain embodiments, it may be advantageous to use a stress crack resistant bottle. Suitable examples of such containers can be found in U.S. Pat. No. 6,464,106 and U.S. Pat. No. 6,223,945.

pH

In one embodiment, the fabric enhancer of the present invention has a pH of about 1 to about 7, in another embodiment from about 2 to about 6.5, in another embodiment from about 4 to about 6 in another embodiment from about 2 to about, in another embodiment from about 2.5 to about 4. In one embodiment the pH of the fabric enhancer is less than 7. It is believed that the acidic nature of the fabric enhancer aids in imparting a softness feel to the fabric, particularly when used in the rinse cycle.

### Perfume Composition

The term “perfume”, as used herein, includes any odoriferous material, other than malodorous impurities that can be present in technical grades of fabric care actives, solvents, and builders. In general, such materials are characterized by a vapor pressure that is less than the atmospheric pressure at ambient temperature. The perfumes employed herein will most often be liquid at ambient temperatures, but may also be solid such as the various camphoraceous perfumes or other sublimable perfumes known in the art. A wide variety of chemicals are known for perfumery uses, including materials such as perfumery aldehydes, ketones, esters, alcohols, terpenes, and the like. Naturally occurring plant and animal oils and exudates comprising complex mixtures of various chemical components are known for use as perfumes, and such materials can be used herein. The perfumes herein can be relatively simple in their composition or can comprise highly sophisticated, complex mixtures of natural and synthetic chemical perfumery components, all chosen to provide any desired odor. In one aspect of this invention, perfumes comprise at least one perfume raw material. Perfume raw materials are compositions that can be used in combination with each others to create various scents.

Typical perfumes which can be used in the present invention comprise, for example, woody/earthy bases containing exotic materials such as sandalwood oil, civet, patchouli oil and the like. Other suitable perfumes are for example light, floral fragrances, e.g., rose extract, violet extract and the like. Perfumes can be formulated to provide desirable fruity odors, e.g., lime, lemon, orange, and the like.

In short, any chemically compatible material which emanates a pleasant or otherwise desirable odor may be used as a perfume. Perfume materials are described more fully in S. Arctander, Perfume Flavors and Chemicals. Vols. I and II. Author, Montclair, N.J., and the Merck Index, 13th Edition, Merck & Co., Inc. Rahway, N.J.

The terms “malodor” and “malodorous”, as used herein include, but are not limited to, enzyme derived, short-chain fatty acids, or nitrogenous compounds such as amines, polyamines, amine oxide surfactants, amides, alkanolamines, ammonia, or ammonium-containing moieties.

In certain embodiments, perfumes for use herein can be encapsulated or microencapsulated. Encapsulated perfume may be dispersed throughout the polymeric material of the fabric enhancer-non-copourable perfume composition. Perfumes for use herein can also be added as neat perfume. Neat perfumes are not encapsulated or microencapsulated. Rather, neat perfumes are typically liquids or solids that are to the fabric enhancer.

Alternatively, one or more perfumery compounds which are incorporated in a fabric enhancer-copourable perfume composition may be encapsulated. In one embodiment the encapsulated perfumery compounds that are in the fabric enhancer-copourable composition are absent from the fabric enhancer-copourable perfume composition. In certain embodiments fabric enhancer-copourable perfume compositions may be encapsulated while the fabric enhancer-non-copourable perfume itself is dispersed throughout a polymeric material such as a low-melting thermoplastic, e.g., a hot-melt adhesive; optionally in combination with conventional plasticizers and/or tackifiers.

As used herein, “encapsulation” is art-recognized and refers to the formation of a shell which completely surrounds a small amount of the perfume. The shell material may be identical to a polymer composition of the fabric enhancer-non-copourable perfume, or may comprise any other ingredient that do not detract from the polymer composition properties both prior to and after rupturing of the shell to release the perfume. Similarly, the perfume may be encapsulated in a shell that itself, along with other capsules, is encapsulated. In another embodiment, the capsule shell wall material comprises organic polymers such as gelatin, urea-formaldehyde, polyurethane, melamine-formaldehyde, or combinations thereof.

In certain embodiments, the fabric enhancer-copourable perfume composition has an olfactory character that matches that of the fabric enhancer-non-copourable perfume composition. In certain alternative embodiments, the fabric enhancer-copourable perfume composition has an olfactory character that is different from that of the fabric enhancer-non-copourable perfume composition.

Perfumes are typically composed of many components of different volatility. The fabric enhancer-non-copourable perfume composition, in one embodiment, avoids separation of the components based on their different volatility and allows the sustained delivery of the full perfume bouquet for a long time. In certain preferred embodiments, the perfume is a perfume which is, in one embodiment, composed by a plurality of components, in one embodiment by more than 5 components.

In one aspect, suitable perfume raw materials having a boiling point less than or equal to 250° C. and a ClogP less than or equal to 2.5 are those materials listed in Table 1 below and such materials are defined as Table 1 perfume raw materials.

TABLE 1

| Number | Registry Name | Trade Name |
|---|---|---|
| 1 | Propanoic acid, ethyl ester | Ethyl Propionate |
| 2 | Acetic acid, 2-methylpropyl ester | Isobutyl Acetate |
| 3 | Butanoic acid, ethyl ester | Ethyl Butyrate |
| 4 | Butanoic acid, 2-methyl-, ethyl | Ethyl-2-Methyl |
| | ester | Butyrate |
| 5 | 2-Hexenal, (E)- | 2-Hexenal |
| 6 | 1-Butanol, 3-methyl-, acetate | Iso Amyl-Acetate |
| 7 | 2-Buten-1-ol, 3-methyl-, acetate | Prenyl Acetate |
| 8 | 2-Hexen-1-ol | Beta Gamma Hexenol |
| 9 | 3-Hexen-1-ol | Beta Gamma Hexenol |
| 10 | Benzaldehyde | Benzaldehyde |
| 11 | 3-Hexen-1-ol, acetate, (Z)- | Cis 3 Hexenyl Acetate |
| 12 | Benzoic acid, methyl ester | Methyl Benzoate |
| 13 | Benzeneacetaldehyde | Phenyl Acetaldehyde |
| 14 | Benzeneacetic acid, methyl ester | Methyl Phenyl |
| | | Acetate |
| 15 | 1,3-Dioxolane-2-acetic acid, 2- | Fructone |
| | methyl-, ethyl ester | |
| 16 | Benzeneacetaldehyde, .alpha.- | Hydratropic Aldehyde |
| | methyl- | |
| 17 | 3-Cyclohexene-1-carboxaldehyde, | Cyclal C, |
| | 3,5-dimethyl- | |
| 18 | Acetic acid, (2-methylbutoxy)-, 2- | Allyl Amyl Glycolate |
| | propenyl ester | |
| 19 | Benzenemethanol, .alpha.-methyl-, | Methyl Phenyl |
| | acetate | Carbinyl Acetate |
| 20 | Acetic acid, (3-methylbutoxy)-, 2- | Allyl Amyl Glycolate |
| | propenyl ester | |
| 21 | Benzaldehyde, 4-methoxy- | Anisic Aldehyde |
| 22 | Benzeneacetic acid, ethyl ester | Ethyl Phenyl Acetate |
| 23 | 2-Cyclohexen-1-one, 2-methyl-5- | Laevo Carvone |
| | (1-methylethenyl)-, (R)- | |
| 24 | Ethanol, 2,2′-oxybis- | Calone 161 |
| 25 | Acetic acid, 2-phenylethyl ester | Phenyl Ethyl Acetate |
| 26 | Benzoic acid, 2-amino-, methyl | Methyl Anthranilate |
| | ester | |
| 27 | 4,7-Methano-1H-inden-6-ol, | Flor Acetate |
| | 3a,4,5,6,7,7a-hexahydro-, acetate | |
| 28 | Octanal, 7-hydroxy-3,7-dimethyl- | Hydroxycitronellal |
| 29 | 2(3H)-Furanone, 5-ethyldihydro- | Gamma Hexalactone |
| 30 | Phenol, 4-methyl- | Para Cresol |
| 31 | Bicyclo[2.2.1]heptan-2-one, 1,7,7- | Camphor Gum |
| | trimethyl-, (1R)- | |
| 32 | 2H-Pyran, 3,6-dihydro-4-methyl-2- | Nerol Oxide |
| | (2-methyl-1-propenyl)- | |
| 33 | Benzeneethanol, .beta.-methyl- | Hydratropic Alcohol |
| 34 | Benzeneethanol, .alpha.,.alpha.- | Dimethyl Benzyl |
| | dimethyl- | Carbinol |
| 35 | Benzoic acid, 2-(methylamino)-, | Dimethyl Anthranilate |
| | methyl ester | |
| 36 | 2-Propenal, 3-phenyl- | Cinnamic Aldehyde |
| 37 | 2-Propenoic acid, 3-phenyl-, | Methyl Cinnamate |
| | methyl ester | |
| 38 | 4H-Pyran-4-one, 2-ethyl-3- | Ethyl Maltol |
| | hydroxy- | |
| 39 | Acetic acid ethyl ester | Ethyl Acetate |
| 40 | 2-Heptanone | Methyl Amyl Ketone |
| 41 | Acetic acid, pentyl ester | Iso Amyl-Acetate |
| 42 | 3-Octanone | Ethyl Amyl Ketone |
| 43 | 2-Octanone | Methyl Hexyl Ketone |
| 44 | Heptenone, methyl- | Methyl Heptenone |
| 45 | 1-Heptanol | Heptyl Alcohol |
| 46 | 5-Hepten-2-one, 6-methyl- | Methyl Heptenone |
| 47 | Butanoic acid, 3-oxo-, ethyl ester | Ethyl Acetoacetate |
| 48 | Ethanol, 2-(2-methoxyethoxy)- | Veramoss Sps |
| 49 | Tricyclo[2.2.1.02,6]heptane, 1- | Neoproxen |
| | ethyl-3-methoxy- | |
| 50 | Benzene, 1,4-dimethoxy- | Hydroquinone |
| | | Dimethyl Ether |
| 51 | Carbonic acid, 3-hexenyl methyl | Liffarome |
| | ester, (Z)- | |
| 52 | Oxirane, 2,2-dimethyl-3-(3-methyl- | Myroxide |
| | 2,4-pentadienyl)- | |
| 53 | Ethanol, 2-(2-ethoxyethoxy)- | Diethylene Glycol |
| | | Mono Ethylether |
| 54 | Cyclohexaneethanol | Cyclohexyl Ethyl |
| | | Alcohol |
| 55 | 3-Octen-1-ol, (Z)- | Octenol Dix |
| 56 | 3-Cyclohexene-1-carboxaldehyde, | Cyclovertal |
| | 3,6-dimethyl- | |
| 57 | 1,3-Oxathiane, 2-methyl-4-propyl-, | Oxane |
| | cis- | |
| 58 | Acetic acid, 4-methylphenyl ester | Para Cresyl Acetate |
| 59 | Benzene, (2,2-dimethoxyethyl)- | Phenyl Acetaldehyde |
| | | Dimethyl Acetal |
| 60 | Ethanone, 1-(4-methylphenyl)- | Para Methyl |
| | | Acetophenone |
| 61 | Propanoic acid, phenylmethyl ester | Benzyl Propionate |
| 62 | Octanal, 7-methoxy-3,7-dimethyl- | Methoxycitronellal Pq |
| 63 | Linalool oxide | Linalool Oxide |
| 64 | 2H-1-Benzopyran-2-one, | Octahydro Coumarin |
| | octahydro- | |
| 65 | Benzenepropanal, .beta.-methyl- | Trifernal |
| 66 | 4,7-Methano-1H- | Formyltricyclodecan |
| | indenecarboxaldehyde, octahydro- | |
| 67 | 2-Butanone, 4-phenyl- | Benzyl Acetone |
| 68 | Ethanone, 1-(4-methoxyphenyl)- | Para Methoxy |
| | | Acetophenone |
| 69 | Benzoic acid, 2-hydroxy-, methyl | Methyl Salicylate |
| | ester | USP |
| 70 | Propanenitrile, 3-(3-hexenyloxy)-, | Parmanyl |
| | (Z)- | |
| 71 | 1,4-Methanonaphthalen-5(1H)-one, | Tamisone |
| | 4,4a,6,7,8,8a-hexahydro- | |
| 72 | Benzene, [2-(2-propenyloxy)ethyl]- | LRA 220 |
| 73 | Benzenepropanol | Phenyl Propyl |
| | | Alcohol |
| 74 | Ethanol, 2-phenoxy- | Phenoxyethanol |
| 75 | 1H-Indole | Indole |
| 76 | 1,3-Dioxolane, 2-(phenylmethyl)- | Ethylene Glycol |
| | | Acetal/Phenyl Acetaldehy |
| 77 | 2H-1-Benzopyran-2-one, 3,4- | Dihydrocoumarin |
| | dihydro- | |

In one aspect, suitable Table 1 perfume raw materials include perfume raw materials from number 1 to number 39 and mixtures thereof.

In one aspect, suitable Table 1 perfume raw materials include perfume raw materials from number 1 to number 29 and mixtures thereof.

In one aspect, suitable perfume raw materials having boiling point less than or equal to 250° C. and a ClogP greater than 2.5 are those materials listed in Table 2 below and such materials are defined as Table 2 perfume raw materials.

TABLE 2

| Number | Registry Name | Trade Name |
|---|---|---|
| 1 | Bicyclo[2.2.1]heptane, 2,2-dimethyl-3- | Camphene |
| | methylene- | |
| 2 | Bicyclo[3.1.1]heptane, 6,6-dimethyl-2- | Beta Pinene |
| | methylene-, (1S)- | |
| 3 | Bicyclo[3.1.1]hept-2-ene, 2,6,6- | Alpha Pinene |
| | trimethyl- | |
| 4 | Propanoic acid, pentyl ester | Amyl Propionate |
| 5 | 1,6-Octadiene, 7-methyl-3-methylene- | Myrcene |
| 6 | Cyclohexene, 1-methyl-4-(1- | Dipentene |
| | methylethenyl)- | |
| 7 | Cyclohexene, 1-methyl-4-(1- | Terpineolene |
| | methylethenyl)- | |
| 8 | Acetic acid, hexyl ester | Hexyl Acetate |
| 9 | Cyclohexene, 1-methyl-4-(1- | Terpineolene |
| | methylethylidene)- | |
| 10 | Benzene, 1-methoxy-4-methyl- | Para Cresyl Methyl |
| | | Ether |
| 11 | 1-Octen-3-ol, acetate | Amyl Vinyl Carbinyl |
| | | Acetate |
| 12 | Octanal | Octyl Aldehyde |
| 13 | 2-Oxabicyclo[2.2.2]octane, 1,3,3- | Eucalyptol |
| | trimethyl- | |
| 14 | Butanoic acid, pentyl ester | Amyl Butyrate |
| 15 | Heptanoic acid, ethyl ester | Ethyl Oenanthate |
| 16 | 5-Heptenal, 2,6-dimethyl- | Melonal |
| 17 | Hexanoic acid, 2-propenyl ester | Allyl Caproate |
| 18 | 3-Cyclohexene-1-carboxaldehyde, | Ligustral |
| | dimethyl- | |
| 19 | 3-Hexene, 1-(1-ethoxyethoxy)-, (Z)- | Leaf Acetal |
| 20 | Octanal, 3,7-dimethyl- | Dihydrocitronellal |
| 21 | 2-Octynoic acid, methyl ester | Methyl Heptine |
| | | Carbonate |
| 22 | 2-Nonenal | 2 Nonen-1-Al |
| 23 | 1,6-Octadien-3-ol, 3,7-dimethyl- | Linalool |
| 24 | Benzoic acid, ethyl ester | Ethyl Benzoate |
| 25 | 6-Octenal, 3,7-dimethyl- | Citronellal |
| 26 | Cyclohexanol, 1-methyl-4-(1- | Dihydroterpineol |
| | methylethyl)- | |
| 27 | 1-Hexanol, 3,5,5-trimethyl-, acetate | Iso Nonyl Acetate |
| 28 | 3,5-Octadien-2-ol, 2,6-dimethyl-, (?,Z)- | Muguol |
| 29 | Cyclohexanone, 5-methyl-2-(1- | Iso Menthone |
| | methylethyl)-, cis- | |
| 30 | Heptanoic acid, 2-propenyl ester | Allyl Heptoate |
| 31 | Butanoic acid, 3-hexenyl ester, (Z)- | Cis 3 Hexenyl |
| | | Butyrate |
| 32 | 1,6-Octadien-3-ol, 3,7-dimethyl-, | Linalyl Formate |
| | formate | |
| 33 | 3-Cyclohexen-1-ol, 4-methyl-1-(1- | Terpinenol |
| | methylethyl)- | |
| 34 | Bicyclo[2.2.1]heptan-2-ol, 1,3,3- | Fenchyl Alcohol |
| | trimethyl- | |
| 35 | Cyclohexanol, 2-(1,1-dimethylethyl)-, | Verdol |
| | cis- | |
| 36 | 3-Octanol, 3,7-dimethyl-, acetate | Tetrahydro Linayl |
| | | Acetate |
| 37 | Bicyclo[2.2.1]heptan-2-ol, 1,7,7- | Borneol Crystals |
| | trimethyl-, (1S-endo)- | |
| 38 | Decanal | Decyl Aldehyde |
| 39 | 3-Cyclohexene-1- | Alpha Terpineol |
| | methanol, .alpha.,.alpha.,4-trimethyl- | |
| 40 | Cyclohexanol, 5-methyl-2-(1- | Menthol |
| | methylethyl)- | |
| 41 | 3-Cyclohexene-1-carboxaldehyde, | Iso Cyclo Citral |
| | 2,4,6-trimethyl- | |
| 42 | 7-Octen-2-ol, 2,6-dimethyl-, acetate | Dihydro Terpinyl |
| | | Acetate |
| 43 | 2H-Pyran-2-one, 6-butyltetrahydro- | Nonalactone |
| 44 | 3-Hepten-2-one, 3,4,5,6,6-pentamethyl- | Koavone |
| 45 | 1,6-Nonadien-3-ol, 3,7-dimethyl- | Ethyl Linalool |
| 46 | 4-Decenal, (E)- | Decenal (Trans-4) |
| 47 | Terpineol | Terpineol |
| 48 | 7-Octen-2-ol, 2-methyl-6-methylene-, | Myrcenyl Acetate |
| | acetate | |
| 49 | 2-Butenoic acid, 2-methyl-, 3-hexenyl | Cis-3-Hexenyl Tiglate |
| | ester, (E,Z)- | |
| 50 | 1,6-Octadien-3-ol, 3,7-dimethyl-, | Linalyl Acetate |
| | acetate | |
| 51 | Benzene, 1-methoxy-4-(1-propenyl)-, | Anethol Usp |
| | (E)- | |
| 52 | 2-Decenal | 2 Decene-1-Al |
| 53 | 2,6-Octadienal, 3,7-dimethyl- | Citral |
| 54 | 6-Octen-1-ol, 3,7-dimethyl-, formate | Citronellyl Formate |
| 55 | Cyclopentanone, 3-methyl-2-pentyl- | Jasmylone |
| 56 | Undecenal | Iso C-11 Aldehyde |
| 57 | 6-Octen-1-ol, 3,7-dimethyl- | Citronellol |
| 58 | Cyclohexanemethanol, .alpha.,.alpha.,4- | Dihydro Terpinyl |
| | trimethyl-, acetate | Acetate |
| 59 | 3-Cyclohexene-1- | Terpinyl Acetate |
| | methanol, .alpha.,.alpha.,4-trimethyl-, | |
| | acetate | |
| 60 | 2,6-Octadien-1-ol, 3,7-dimethyl-, | Geranyl Formate |
| | formate, (E)- | |
| 61 | Bicyclo[2.2.1]heptan-2-ol, 1,3,3- | Fenchyl Acetate |
| | trimethyl-, acetate | |
| 62 | Bicyclo[2.2.1]heptan-2-ol, 1,7,7- | Iso Bornyl Acetate |
| | trimethyl-, acetate, exo- | |
| 63 | 2,6-Octadien-1-ol, 3,7-dimethyl-, (E)- | Geraniol |
| 64 | 2,6-Octadien-1-ol, 3,7-dimethyl-, (Z)- | Nerol |
| 65 | Cyclohexanol, 2-(1,1-dimethylethyl)-, | Verdox |
| | acetate | |
| 66 | Undecanal, 2-methyl- | Methyl Nonyl |
| | | Acetaldehyde |
| 67 | Undecanal | Undecyl Aldehyde |
| 68 | 2H-Pyran-2-one, tetrahydro-6-pentyl- | Delta Decalactone |
| 69 | 6-Octen-1-ol, 3,7-dimethyl-, acetate | Citronellyl Acetate |
| 70 | 10-Undecenal | Intreleven Aldehyde |
| | | Sp |
| 71 | 2(3H)-Furanone, 5-hexyldihydro- | Gamma Decalactone |
| 72 | 2,6-Octadien-1-ol, 3,7-dimethyl-, | Geranyl Acetate |
| | acetate, (E)- | |
| 73 | 2H-Pyran-2-one, tetrahydro-6-(3- | Jasmolactone |
| | pentenyl)- | |
| 74 | Cyclohexanol, 5-methyl-2-(1- | Menthyl Acetate |
| | methylethyl)-, | |
| | acetate, (1.alpha.,2.beta.,5.alpha.)- | |
| 75 | 2-Undecenal | 2-Undecene-1-Al |
| 76 | 2H-Pyran-2-one, tetrahydro-6-(2- | Jasmolactone |
| | pentenyl)-, (Z)- | |
| 77 | 2,6-Octadien-1-ol, 3,7-dimethyl-, | Neryl Acetate |
| | acetate, (Z)- | |
| 78 | Benzeneethanol, .alpha.,.alpha.- | Dimethyl Benzyl |
| | dimethyl-, acetate | Carbinyl Acetate |
| 79 | 4,9-Decadienal, 4,8-dimethyl- | Floral Super |
| 80 | 3-Octanol | Octanol-3 |
| 81 | 2-Heptanol, 2,6-dimethyl- | Dimethyl-2, 6-Heptan- |
| | | 2-Ol |
| 82 | Propanoic acid, 2-methyl-, 1,3- | Iso Pentyrate |
| | dimethyl-3-butenyl ester | |
| 83 | 3-Nonanone | Ethyl Hexyl Ketone |
| 84 | 2,4,6-Octatriene, 2,6-dimethyl- | Allo-Ocimene |
| 85 | Bicyclo[2.2.1]heptane, 2-ethyl-5- | Neoproxen |
| | methoxy- | |
| 86 | 1-Octanol | Octyl Alcohol |
| 87 | 3-Octanol, 3,7-dimethyl- | Linacsol |
| 88 | Propanoic acid, 2-methyl-, 3-hexenyl | Verdural B Extra |
| | ester, (Z)- | |
| 89 | 2H-Pyran, tetrahydro-4-methyl-2-(2- | Methyl Iso Butenyl |
| | methyl-1-propenyl)- | Tetrahydro Pyran |
| 90 | Nonanal | Nonyl Aldehyde |
| 91 | Hexanoic acid, 2-methylpropyl ester | Iso Butyl Caproate |
| 92 | Cyclohexane, 3-ethoxy-1,1,5-trimethyl- | Herbavert |
| 93 | 7-Octen-2-ol, 2-methyl-6-methylene-, | Dihydro Myrcenol |
| | dihydro deriv. | |
| 94 | Ethanone, 1-(3,3-dimethylcyclohexyl)- | Herbac |
| 95 | Propanoic acid, 2,2-dimethyl-, hexyl | Hexyl Neo Pentanoate |
| | ester | |
| 96 | 3-Heptanone, 5-methyl-, oxime | Stemone |
| 97 | Isononanol | Iso Nonyl Alcohol |
| 98 | Cyclohexanone, 2-(1-methylpropyl)- | 2-Sec-Butyl Cyclo |
| | | Hexanone |
| 99 | Butanoic acid, 2-methyl-, hexyl ester | Hexyl-2-Methyl |
| | | Butyrate |
| 100 | 1-Nonanol | Nonyl Alcohol |
| 101 | Cyclohexaneethanol, acetate | Cyclohexyl Ethyl |
| | | Acetate |
| 102 | 1-Octanol, 3,7-dimethyl- | Dimethyl Octanol |
| 103 | Cyclopentanone, 2-pentyl- | Delphone |
| 104 | Cyclohexanemethanol, 4-(1- | Mayol |
| | methylethyl)-, cis- | |
| 105 | 6-Octen-1-ol, 3,7-dimethyl-, (S)- | Baranol |
| 106 | Benzaldehyde, 4-(1-methylethyl)- | Cuminic Aldehyde |
| 107 | Propanoic acid, 2-methyl-, | Benzyl Iso Butyrate |
| | phenylmethyl ester | |
| 108 | Propanoic acid, 2-methyl-, 4- | Para Cresyl Iso |
| | methylphenyl ester | Butyrate |
| 109 | Carbonic acid, 4-cycloocten-1-yl | Violiff |
| | methyl ester | |
| 110 | 1,6-Octadien-3-ol, 3,7-dimethyl-, | Linalyl Propionate |
| | propanoate | |
| 111 | Cyclohexanemethanol, .alpha.-methyl- | Mugetanol |
| | 4-(1-methylethyl)- | |
| 112 | Butanoic acid, phenylmethyl ester | Benzyl Butyrate |
| 113 | 4,7-Methano-1H-inden-5-ol, octahydro-, | Dihydro Cyclacet |
| | acetate | |
| 114 | 2-Cyclopenten-1-one, 3-methyl-2- | Dihydrojasmone |
| | pentyl- | |
| 115 | Bicyclo[2.2.1]heptan-2-ol, 1,7,7- | Iso Bornyl Propionate |
| | trimethyl-, propanoate, exo- | |
| 116 | 2,6-Octadienenitrile, 3,7-dimethyl- | Geranyl Nitrile |
| 117 | Benzene, ethenyl- | Styrene |
| 118 | Benzene, methyl(1-methylethyl)- | Cymene Coeur |
| 119 | Cyclohexanol, 3,3,5-trimethyl-, cis- | Trimethylcyclohexanol |
| 120 | 1-Hexanol, 5-methyl-2- | Tetrahydro Lavandulol |
| | (1-methylethyl)-, (R)- | |
| 121 | Cyclohexanol, 4-(1-methylethyl)- | Roselea |
| 122 | 7-Octen-2-ol, 2,6-dimethyl-, formate | Dimyrcetol |
| 123 | Cyclohexanone, 5-methyl-2-(1- | Menthone Racemic |
| | methylethyl)-, trans- | |
| 124 | 1,3,5-Undecatriene | Galbanolene Super |
| 125 | 5,7-Octadien-2-ol, 2,6-dimethyl- | Ocimenol |
| 126 | 2-Cyclohexene-1-carboxylic acid, | Methyl Cyclogeranate |
| | 2,6,6-trimethyl-, methyl ester | |
| 127 | Benzene, (2-bromoethenyl)- | Brom Styrol |
| 128 | Benzene, 1-methoxy-4-(2-propenyl)- | Methyl Chavicol |
| 129 | 2H-Pyran, 6-butyl-3,6-dihydro-2,4- | |
| | dimethyl- | Gyrane |
| 130 | Cyclohexanemethanol, .alpha.,3,3- | Aphermate |
| | trimethyl-, formate | |
| 131 | Cyclohexanol, 4-(1,1-dimethylethyl)- | Patchon |
| 132 | Cyclohexanol, 5-methyl-2-(1- | Menthol Natural |
| | methylethyl)-, | |
| | [1R-(1.alpha.,2.beta.,5.alpha.)]- | |
| 133 | 1,3-Dioxane, 2-butyl-4,4,6-trimethyl- | Herboxane |
| 134 | 2-Nonynoic acid, methyl ester | Methyl Octine |
| | | Carbonate |
| 135 | 6-Octenenitrile, 3,7-dimethyl- | Baranyl Nitrile |
| 136 | Decanal, 2-methyl- | Methyl Octyl |
| | | Acetaldehyde |
| 137 | 2-Nonanol, 6,8-dimethyl- | Nonadyl |
| 138 | Phenol, 4-(1,1-dimethylethyl)- | Para Tertiary Butyl |
| | | Phenol |
| 139 | 1-Hexanol, 5-methyl-2-(1- | Tetrahydro Lavandulyl |
| | methylethyl)-, acetate | Acetate |
| 140 | Cyclohexanol, 5-methyl-2-(1- | Iso Pulegol |
| | methylethenyl)-, [1R- | |
| | (1.alpha.,2.beta.,5.alpha.)]- | |
| 141 | Cyclohexanone, 4-(1,1- | Orivone |
| | dimethylpropyl)- | |
| 142 | 2-Undecanone | Methyl Nonyl Ketone |
| 143 | Cyclohexanemethanol, .alpha.,3,3- | Rosamusk |
| | trimethyl-, acetate | |
| 144 | 3-Cyclohexene-1-methanol, 2,4,6- | Isocyclogeraniol |
| | trimethyl- | |
| 145 | 2,6-Octadiene, 1,1-dimethoxy-3,7- | Citral Dimethyl Acetal |
| | dimethyl- | |
| 146 | 1-Decanol | Rhodalione |
| 147 | 2-Cyclohexen-1-one, 3-methyl-5- | Livescone |
| | propyl- | |
| 148 | Phenol, 2-methyl-5-(1-methylethyl)- | Carvacrol |
| 149 | 2-Naphthalenol, decahydro- | Trans Deca Hydro |
| | | Beta Naphthol |
| 150 | Cyclohexanol, 4-(1,1-dimethylethyl)-, | Tertiary Butyl |
| | acetate | Cyclohexyl Acetate |
| 151 | 9-Decen-1-ol | Rosalva |
| 152 | Phenol, 5-methyl-2-(1-methylethyl)- | Thymol Nf |
| 153 | Cyclohexanol, 5-methyl-2-(1- | Iso Pulegol Acetate |
| | methylethenyl)-, acetate, [1R- | |
| | (1.alpha.,2.beta.,5.alpha.)]- | |
| 154 | Benzene, [(3-methylbutoxy)methyl]- | Iso Amyl Benzyl Ether |
| 155 | 2(3H)-Furanone, 5-hexyldihydro-5- | Lactojasmon |
| | methyl- | |
| 156 | Benzoic acid, butyl ester | Butyl Benzoate |
| 157 | Bicyclo[3.2.1]octan-8-one, 1,5- | Buccoxime |
| | dimethyl-, oxime | |
| 158 | 2-Cyclopenten-1-one, 2-methyl-3-(2- | Iso Jasmone |
| | pentenyl)- | |

In one aspect, suitable Table 2 perfume raw materials include perfume raw materials from number 1 to number 116 and mixtures thereof.

In one aspect, suitable Table 2 perfume raw materials include perfume raw materials from number 1 to number 79 and mixtures thereof.

In one aspect, suitable perfume raw materials having boiling point greater than 250° C. but less than or equal to 280° C. are those materials listed in Table 3 below and such materials are defined as Table 3 perfume raw materials.

TABLE 3

| Number | Registry Name | Trade Name |
|---|---|---|
| 1 | Dodecanenitrile | Clonal |
| 2 | Cyclohexanepropanoic acid, 2- | Allyl Cyclohexane |
| | propenyl ester | Propionate |
| 3 | 2-Buten-1-one, 1-(2,6,6-trimethyl-2- | Alpha Damascone |
| | cyclohexen-1-yl)- | |
| 4 | 1,4-Cyclohexanedicarboxylic acid, | Fructalate |
| | diethyl ester | |
| 5 | 2(3H)-Furanone, 5-heptyldihydro- | Undecalactone |
| 6 | Naphthalene, 2-methoxy- | Beta Naphthol Methyl |
| | | Ether |
| 7 | Benzenepropanal, 4-(1,1- | Bourgeonal |
| | dimethylethyl)- | |
| 8 | 3-Cyclopentene-1- | Brahmanol |
| | butanol, .beta.,2,2,3-tetramethyl- | |
| 9 | 1H-3a,7-Methanoazulen-6-ol, | Cedrol |
| | octahydro-3,6,8,8-tetramethyl-,[3R- | |
| | (3.alpha.,3a.beta.,6.alpha.,7.beta.,8a.alpha.)]- | |
| 10 | 2-Propen-1-ol, 3-phenyl-, acetate | Cinnamyl Acetate |
| 11 | Benzenepropanal, .alpha.-methyl-4- | Cymal |
| | (1-methylethyl)- | |
| 12 | 2-Buten-1-one, 1-(2,6,6-trimethyl-1- | Damascone Beta |
| | cyclohexen-1-yl)-, (Z)- | |
| 13 | 2-Buten-1-one, 1-(2,6,6-trimethyl- | Damascenone |
| | 1,3-cyclohexadien-1-yl)- | |
| 14 | 2-Buten-1-one, 1-(2,6,6-trimethyl-3- | Delta Damascone |
| | cyclohexen-1-yl)- | |
| 15 | Butanoic acid, 1,1-dimethyl-2- | Dimethyl Benzyl |
| | phenylethyl ester | Carbinyl Butyrate |
| 16 | 2-Dodecenal | 2 Dodecene-1-Al |
| 17 | 2H-Pyran-2-one, 6-heptyltetrahydro- | Dodecalactone |
| 18 | Oxiranecarboxylic acid, 3-methyl-3- | Ethyl Methyl Phenyl |
| | phenyl-, ethyl ester | Glycidate |
| 19 | Oxiranecarboxylic acid, 3-phenyl-, | Ethyl Phenyl Glycidate |
| | ethyl ester | |
| 20 | Phenol, 2-methoxy-4-(2-propenyl)- | Eugenol |
| 21 | Benzenepropanal, .beta.-methyl-3-(1- | Florhydral |
| | methylethyl)- | |
| 22 | Benzenepropanal, 2-ethyl-. | Floralozone |
| | alpha.,.alpha.-dimethyl- | |
| 23 | 4,7-Methano-1H-inden-6-ol, | Frutene |
| | 3a,4,5,6,7,7a-hexahydro-, propanoate | |
| 24 | 2,6-Octadienenitrile, 3,7-dimethyl-, | Geranyl Nitrile |
| | (E)- | |
| 25 | 1,3-Benzodioxole-5-carboxaldehyde | Heliotropin |
| 26 | Ionone | Ionone Ab |
| 27 | 3-Buten-2-one, 4-(2,6,6-trimethyl-2- | Onone Alpha |
| | cyclohexen-1-yl)-, (E)- | |
| 28 | 3-Buten-2-one, 4-(2,6,6-trimethyl-1- | Ionone Beta |
| | cyclohexen-1-yl)- | |
| 29 | 3-Buten-2-one, 4-(2,6,6-trimethyl-1- | Ionone Beta |
| | cyclohexen-1-yl)-, (E)- | |
| 30 | 3-Buten-2-one, 3-methyl-4-(2,6,6- | Ionone Gamma Methyl |
| | trimethyl-2-cyclohexen-1-yl)- | |
| 31 | 2-Buten-1-one, 1-(2,4,4-trimethyl-2- | Isodamascone N |
| | cyclohexen-1-yl)-, (E)- | |
| 32 | Phenol, 2-methoxy-4-(1-propenyl)- | Iso Eugenol |
| 33 | 2H-Pyran-4-ol, tetrahydro-3-pentyl-, | Jasmal |
| | acetate | |
| 34 | Bicyclo[3.1.1]hept-2-ene-2-ethanol, | Nopyl Acetate |
| | 6,6-dimethyl-, acetate | |
| 35 | Benzenepropanol, .alpha.,.alpha.- | Phenyl Ethyl Dimethyl |
| | dimethyl-, acetate | Carbinyl Acetate |
| 36 | Propanoic acid, 2-methyl-, | Cyclabute |
| | 3a,4,5,6,7,7a-hexahydro-4,7-methano-1H- | |
| 37 | Benzaldehyde, 4-hydroxy-3-methoxy- | Vanillin |
| 38 | 3-Cyclohexene-1-carboxaldehyde, 1- | Vernaldehyde |
| | methyl-4-(4-methylpentyl)- | |
| 39 | Benzenemethanol, ar-methoxy-, | Anisyl Acetate |
| | acetate | |
| 40 | Bicyclo[2.2.1]hept-5-ene-2- | Herbanate Ci |
| | carboxylic acid,3-(1-methylethyl)-,ethyl | |
| | ester, (2-endo,3-exo)- | |
| 41 | Butanoic acid, 3-methyl-, 2- | Beta Phenyl Ethyl |
| | phenylethyl ester | Isovalerate |
| 42 | Benzenepropanal, 4-methoxy-.alpha.- | Canthoxal |
| | methyl- | |
| 43 | Bicyclo[7.2.0]undec-4-ene, 4,11,11- | Caryophyllene Extra |
| | trimethyl-8-methylene-,[1R-(1R*,4E,9S*)]- | |
| 44 | Cyclohexenebutanal, .alpha.,2,2,6- | Cetonal |
| | tetramethyl- | |
| 45 | 2-Propen-1-ol, 3-phenyl- | Cinnamic Alcohol |
| 46 | 6-Octen-1-ol, 3,7-dimethyl-, | Citronellyl Propionate |
| | propanoate | |
| 47 | Propanoic acid, decyl ester | N-Decyl Propionate |
| 48 | Phenol, 2-methoxy-4-propyl- | Dihydro Eugenol |
| 49 | Cyclohexanol, 1-ethenyl-2-(1- | Dihydro Ambrate |
| | methylpropyl)-, acetate | |
| 50 | 2-Propenoic acid, 3-phenyl-, ethyl | Ethyl Cinnamate |
| | ester | |
| 51 | Butanoic acid, 3,7-dimethyl-2,6- | Geranyl Butyrate |
| | octadienyl ester, (E)- | |
| 52 | 2-Octanol, 8,8-dimethoxy-2,6- | Hydroxycitronellal |
| | dimethyl- | Dimethyl Acetal |
| 53 | Cyclohexadieneethanol, 4-(1- | Iso Bergamate |
| | methylethyl)-, formate | |
| 54 | Dodecanal | Lauric Aldehyde |
| 55 | Propanoic acid, 2-methyl-, 1-ethenyl- | Linalyl Iso Butyrate |
| | 1,5-dimethyl-4-hexenyl ester | |
| 56 | Benzenepropanol, .beta.,.beta.,3- | Majantol |
| | trimethyl- | |
| 57 | Benzene, 1,2-dimethoxy-4-(2- | Methyl Eugenol |
| | propenyl)- | |
| 58 | Propanoic acid, 2-methyl-, 2- | Phenyl Ethyl Iso |
| | phenylethyl ester | Butyrate |
| 59 | 2-Propenenitrile, 3-phenyl- | Cinnamalva |
| 60 | Benzene, [2-(1-propoxyethoxy)ethyl]- | Acetal R |
| 61 | 9-Undecenal, 2,6,10-trimethyl- | Adoxal |
| 62 | 2-Naphthalenol, 1,2,3,4,4a,5,6,7- | Ambrinol 20t |
| | octahydro-2,5,5-trimethyl- | |
| 63 | 2-Naphthalenol, octahydro-2,5,5- | Ambrinol 20t |
| | trimethyl- | |
| 64 | Ethanol, 2-[(1,7,7- | Arbanol |
| | trimethylbicyclo[2.2.1]hept-2-yl)oxy]-, exo- | |
| 65 | 1H-2-Benzopyran, 3,4,4a,5,8,8a(or | Bigarade Oxide |
| | 3,4,4a,7,8,8a)-hexahydro-3,3,6,7- | |
| 66 | Cyclohexene, 4-(1,5-dimethyl-4- | Bisabolene |
| | hexenylidene)-1-methyl- | |
| 67 | 1H-3a,7-Methanoazulene, octahydro- | Cedramber |
| | 6-methoxy-3,6,8,8-tetramethyl-,[3R- | |
| | (3.alpha.,3a.beta.,6.alpha.,7.beta.,8a.alpha.)]- | |
| 68 | Phenol, 4-chloro-3,5-dimethyl- | 4-Chloro 3,5 Xylenol |
| 69 | 2,6-Octadiene, 1,1-diethoxy-3,7- | Citrathal |
| | dimethyl- | |
| 70 | Acetaldehyde, [(3,7-dimethyl-6- | Citronellyl |
| | octenyl)oxy]- | Oxyacetaldehyde |
| 71 | Benzenepropanenitrile, .alpha.- | Citrowanil B |
| | ethenyl-.alpha.-methyl- | |
| 72 | Cyclohexanol, 2-(1,1- | Coniferan |
| | dimethylpropyl)-, acetate | |
| 73 | 2H-1-Benzopyran-2-one | Coumarin |
| 74 | 1,3-Nonanediol, monoacetate | Diasmol |
| 75 | Benzene, 1,1′-methylenebis- | Diphenyl Methane |
| 76 | Benzene, 1,1′-oxybis- | Diphenyl Oxide |
| 77 | 1,6-Octadiene, 3-(1-ethoxyethoxy)- | Elinthal |
| | 3,7-dimethyl- | |
| 78 | Cyclopentanone, 2-heptyl- | Fleuramone |
| 79 | 5,8-Methano-2H-1-benzopyran-2- | Florex |
| | one, 6-ethylideneoctahydro- | |
| 80 | Octanoic acid, 2-acetyl-, ethyl ester | Gelsone |
| 81 | Indeno[1,2-d]-1,3-dioxin, 4,4a,5,9b- | Indoflor Crist. |
| | tetrahydro- | |
| 82 | Benzeneacetic acid, 2-methylpropyl | Iso Butyl Phenylacetate |
| | ester | |
| 83 | 2,6-Nonadienenitrile, 3,7-dimethyl- | Lemonile |
| 84 | 3-Decanone, 1-hydroxy- | Methyl Lavender |
| | | Ketone |
| 85 | Undecane, 1,1-dimethoxy-2-methyl- | Methyl Nonyl |
| | | Acetaldehyde Dimethyl Aceta |
| 86 | 1-Propanone, 1-[2-methyl-5-(1- | Nerone |
| | methylethyl)-2-cyclohexen-1-yl]- | |
| 87 | 5,9-Undecadienal, 2,6,10-trimethyl- | Oncidal |
| 88 | Quinoline, 6-methyl- | Para Methyl Quinoline |
| 89 | Propanoic acid, 2-methyl-, 2- | Phenoxy Ethyl Iso |
| | phenoxyethyl ester | Butyrate |
| 90 | Ethanol, 2-phenoxy-, propanoate | Phenoxy Ethyl |
| | | Propionate Formerly N-225 |
| 91 | 4,7-Methano-1H-indene-2- | Scentenal |
| | carboxaldehyde, octahydro-5-methoxy- | |
| 92 | 9-Undecen-2-one, 6,10-dimethyl- | Tetra Hydro Psuedo |
| | | Ionone |
| 93 | Benzenemethanol, .alpha.- | Trichloromethyl Phenyl |
| | (trichloromethyl)-, acetate | Carbinyl Acetate |
| 94 | Phenol, 2-methoxy-4- | Vaniwhite |
| | (methoxymethyl)- | |
| 95 | Bicyclo[2.2.2]oct-5-ene-2- | Maceal |
| | carboxaldehyde, 6-methyl-8-(1-methylethyl)- | |
| 96 | Benzene, [2-(3-methylbutoxy)ethyl]- | Phenyl Ether Isamyl |
| | | Ether (Aka Anther) |
| 97 | 2-Cyclohexene-1-carboxylic acid, | Givescone |
| | 2,3,6,6-tetramethyl-, ethyl ester | |

In one aspect, suitable Table 3 perfume raw materials include perfume raw materials from number 1 to number 58 and mixtures thereof.

In one aspect, suitable Table 3 perfume raw materials include perfume raw materials from number 1 to number 39 and mixtures thereof.

Suitable perfume raw materials and accords may be obtained from one or more of the following companies Firmenich (Geneva, Switzerland), Givaudan (Argenteuil, France), IFF (Hazlet, N.J. U.S.A.), Quest (Mount Olive, N.J. U.S.A), Bedoukian (Danbury, Conn.), Sigma Aldrich (St. Louis, Mo. U.S.A), Millennium Specialty Chemicals (Olympia Fields, Ill. U.S.A), Polarone International (Jersey City, N.J. U.S.A), Fragrance Resources (Keyport, N.J. U.S.A), and Aroma & Flavor Specialties (Danbury, Conn. U.S.A).

### Fabric Enhancer-Non-Copourable Perfume Composition

The fabric enhancer product comprises a fabric enhancer-non-copourable perfume composition. Suitable fabric enhancer-non-copourable perfume compositions for use herein include the polymeric compositions for sustained release of volatile materials described in WO 2005/049717 A2. Over and above any perfumes or malodors which can enter the headspace by volatilization from the fabric enhancer (when such materials are present therein), the fabric enhancer-non-copourable perfume composition provides an effective technology for diffusing a perfume throughout the headspace. In one embodiment, the polymeric composition associated with the fabric enhancer-non-copourable perfume composition for sustained release is considered a polymer assisted delivery (PAD) matrix system.

In certain embodiments, the release of perfume from the fabric enhancer-non-copourable perfume composition is passive.

The term “passive” as used herein is meant to include routes of release of the perfume composition, such as by diffusion, which does not require intervention by the user. In contrast, “active” routes of release require action by the user, including, but not limited to, squeezing of a perfume from a suitable medium, such as a sponge, or by a twisting action, to release the perfume composition. In passive release, in one embodiment, even when subjected to closure or shaking of the package, the rate of release of the perfume composition remains unchanged, i.e., rapid and/or intermittent release of the perfume composition is not the primary mechanism of release.

In certain embodiments, the fabric enhancer-non-copourable composition is affixed to an internal portion of the package, provided that when the fabric enhancer-non-copourable perfume composition is meltable, the fabric enhancer-non-copourable perfume composition has a pouring temperature of at least about 5° C., at least about 10° C., or even at least about 15° C. above the ambient storage temperature.

The fabric enhancer-non-copourable perfume composition may be located in the container, the transition component, the closure, or any combination thereof. The fabric enhancer-non-copourable perfume composition may be formed into any of various shapes including rings, annular disks, circles, squares, rectangle, or any other shape that is suited to the shape of the space of in which the fabric enhancer-non-copourable perfume composition is to be incorporated. In certain embodiments, the fabric enhancer-non-copourable perfume composition is located in the transition component of the package, or into an element forming a self-draining dispensing orifice rather than in a cap or closure.

In certain embodiments, the fabric enhancer-non-copourable perfume composition is adsorbed onto or affixed to a solid having dimensions larger than the outlet of the package and floatable in the fabric enhancer; provided that when the perfume composition is meltable, the pouring temperature thereof is at least 5° C. above the ambient storage temperature. In certain such embodiments, the fabric enhancer-non-copourable perfume composition is in the form of a hollow sphere, however, the fabric enhancer-non-copourable perfume composition may be in any suitable shape, either hollow or solid, including, but not limited to, a sheet, star, flower, disk, rectangle, square, or any other shape, provided that the fabric enhancer-non-copourable perfume composition is dimensioned such that it is larger than the outlet of the package and provided that it is floatable in the fabric enhancer. In certain embodiments, it may be advantageous for the package to be transparent and for the fabric enhancer-non-copourable perfume composition to be any one of a number of shapes and/or colors. In certain embodiments, the fabric enhancer-non-copourable perfume composition may have more than one color. In certain embodiments, the package may contain more than one fabric enhancer-non-copourable perfume composition. Moreover, the fabric enhancer-non-copourable perfume composition may be directly or indirectly affixed to a component of the package. For example, an indirect affixing method involves having a perfumed hot-melt adhesive set upon a thin plastic film, e.g., of HDPE, which is in turn bonded to a packaging element by means of a separate adhesive material such as an adhesive tape. Thus, the stickiness of the fabric enhancer-non-copourable perfume composition is not always critical.

In certain embodiments, the fabric enhancer-non-copourable perfume composition comprises a perfume and a polymeric composition, in one embodiment the fabric enhancer-non-copourable perfume composition has the ability to release the perfume in a sustained manner, i.e. with a relatively constant release rate and for a long period of time, such that there is still a detectable amount of perfume in the fabric enhancer-non-copourable perfume composition when the fabric enhancer has been used or only a residual amount of the fabric enhancer remains in the container. In certain preferred such embodiments, release of the perfume of the fabric enhancer-non-copourable perfume composition is substantially unchanged even when repeatedly contacted with the fabric enhancer. In other words, the fabric enhancer does not itself extract the perfume from the fabric enhancer-non-copourable perfume composition.

Unless otherwise specifically indicated, the phrase “polymeric composition” herein refers to a thermoplastic polymeric composition that can be used to deliver the perfumes in the fabric enhancer-non-copourable perfume composition. The term “polymeric composition” as used herein differs from packaging plastics. In one embodiment, a “polymeric composition” has a softening temperature at least about 10° C. below that of packaging plastics used for bottle making, but remains non-pourable at temperatures of at least about 35° C. in the absence of added perfume.

In certain embodiments, the perfume of the fabric enhancer-non-copourable perfume composition is released by diffusion into the headspace. In certain such embodiments, the fabric enhancer-non-copourable perfume composition may optionally be separated from the fabric enhancer by a permeable liner element, though such an element is not essential. In certain such embodiments, the liner is permeable to the perfume materials, but impermeable to the fabric enhancer. In general, the fabric enhancer-non-copourable perfume composition can be allowed to come into contact with the fabric enhancer.

In general, proportions by weight of fabric enhancer-non-copourable perfume composition to fabric enhancer can vary widely, e.g., from about 0.01 grams to about 2 grams, in another embodiment from about 0.05 grams to about 1 gram, in another embodiment from about 0.1 grams to about 0.8 grams of fabric enhancer-non-copourable perfume composition are sufficient for perfuming products comprising up to about 3 kg of fabric enhancer.

In certain embodiments, the fabric enhancer-non-copourable perfume composition comprises from about 1 wt % to about 80 wt % of perfume, in one embodiment from about 10 wt % to about 60 wt %. In certain such embodiments, the balance of the fabric enhancer-non-copourable composition comprises thermoplastic polymers, plasticizers, tackifiers, or any combination thereof.

When the product as a whole comprises both a fabric enhancer-non-copourable perfume composition and a fabric enhancer-copourable perfume composition, the weight ratio of perfume in the fabric enhancer-copourable composition to perfume in the fabric enhancer-non-copourable perfume composition is from about 0:1 to about 1:0.

When the product as a whole comprises both a fabric enhancer-non-copourable perfume composition and a fabric enhancer-copourable perfume composition and the sum of these is taken as 100% of all perfume in the product, then an effective amount of fabric enhancer-non-copourable perfume composition may be as low as about 0.001 wt %, more typically from about 0.01 to about 3 wt % (i.e., up to three hundredths by weight) of all perfume in the product.

In another embodiment, the fabric enhancer can be unperfumed and a suitable amount of fabric enhancer-non-copourable composition will comprise 100 wt % of all perfume.

In a particularly preferred embodiment, the fabric enhancer-copourable perfume composition may comprise up to about 0.1%, in one embodiment up to about 50%, in one embodiment up to about 100% of fabric substantive perfume raw materials.

In certain embodiments, it may be advantageous to minimize the amount of fabric enhancer-copourable perfume which may be susceptible to interaction with other fabric enhancer ingredients, for example by having a level of fabric enhancer-copourable perfumes of less than about 20%, less than about 10%, or even less than about 1% of the total of perfume in the product. In certain such embodiments, it may be advantageous to encapsulate the fabric enhancer-copourable perfumes in a polyamine shell.

Suitable polymeric compositions are capable of effectively delivering a wide variety of perfumes in a broad polarity range, and also adhere well to plastic packaging construction materials such as high density polyethylene, polyethylene terephthalate, polypropylene and the like. Suitable polymeric compositions may further comprise additives which allow the tuning of its polarity characteristics very precisely. This makes it possible to maximize the compatibility with any perfume which could be introduced in the plasticized polymeric matrix thus obtaining a polymeric composition according to the present invention. Without being bound by theory, it is believed that a certain polarity match between the plasticized polymeric matrix and the perfume is required to provide good incorporation and sustained delivery of the perfume.

In certain embodiments, the polymeric composition may be formed into a material selected from a film, a sheet, a foam, or an adhesive. In certain embodiments, the polymeric composition is formed into an adhesive, in one embodiment a solidified hot-melt adhesive.

In certain embodiments, the fabric enhancer-non-copourable perfume composition is a solidified hot-melt adhesive that further comprises at least one plasticizer, at least one tackifier, or any combination thereof.

In certain embodiments, the fabric enhancer-non-copourable perfume composition is insoluble in the fabric enhancer.

The fabric enhancer-non-copourable perfume composition may be affixed to the package using any suitable method. In certain such embodiments, the surface of the package to which the fabric enhancer-non-copourable perfume composition is affixed is first subjected to localized roughing. Methods for such localized roughing are well known in the art, e.g., by abrasion of an otherwise smooth packaging plastic.

In certain embodiments, suitable polymeric compositions can be formulated as hot-melt adhesives that have a low application temperature, in one embodiment below about 100° C. and in some cases below about 70° C. This is a particularly desirable property for materials used to incorporate perfumes as the higher is the processing temperature, the greater is the risk of losing by evaporation significant amounts of the perfume incorporated during the manufacturing of the composition. Moreover, higher application or processing temperatures may increase safety hazards associated with processing of the polymeric compositions. Examples of suitable hot-melt adhesives may be found in U.S. Pat. No. 6,084,010 and U.S. Pat. No. 5,827,913.

The solidified perfumed hot-melt adhesive may be produced by processing a thermoplastic resin with perfumes to form a homogeneous mixture at process temperatures less than about 85° C. In certain such embodiments, the thermoplastic resin is added to a fluid comprising perfume. Accordingly, a method for producing a solidified perfumed hot-melt adhesive comprises processing a thermoplastic resin with perfumes to form a homogeneous mixture at process temperatures less than about 85° C. In certain embodiments, the method comprises processing the thermoplastic resin by adding it to a fluid comprising perfume.

In certain embodiments, the polymeric composition comprises a) a copolymer of ethylene with at least another monomer comprising at least one heteroatom; and b) more than 10% of a plasticizer comprising at least a heteroatom. Such compositions may be formed into films, sheets, foams, and adhesives, or hot-melt adhesives. These hot-melt adhesive compositions have good adhesion on most substrates (plastic films, foams, cardboard, and the like).

Suitable copolymers may be block or non-block copolymers, grafted copolymers, copolymers with side chains, or crosslinks, or copolymers where ethylene monomers are randomly copolymerized with monomers comprising at least one heteroatom.

Suitable copolymers of ethylene are, for example, ethylene-vinyl ester copolymers, ethylene-acrylic ester copolymers, ethylene-methacrylic ester copolymers, ethylene-acrylic acid copolymers and their salts, ethylene-methacrylic acid copolymers and their salts, ethylene-vinyl ester-acrylic acid copolymers, ethylene-vinyl ester-methacrylic acid copolymers, ethylene-vinyl ester-maleic anhydride copolymers, ethylene-acrylic ester-maleic anhydride copolymers, ethylene-vinyl ester-glycidyl methacrylate copolymers, ethylene-acrylic ester-glycidyl methacrylate copolymers, ethylene-maleic anhydride copolymers, ethylene-glycidyl methacrylate copolymers.

The monomer comprising at least one heteroatom in the copolymers in one embodiment represents from 10% to 90% of the total weight of the copolymer, in one embodiment at least 14% in one embodiment at least 18%.

Particularly preferred copolymers are ethylene-vinyl acetate copolymers such as those sold under the trade names Elvax™ by Dupont, Evathane™ by Atofina, Escorene™ by Exxon and Levapren™ and Levamelt™ by Bayer and ethylene-acrylic ester copolymers such as those sold under the trade name Lotryl™ by Atofina.

The term “monomer comprising at least a heteroatom” includes all those monomers which comprise at least a C—X linkage in the molecule wherein X is not C or H. Said C—X linkage is in one embodiment a polar linkage. In one embodiment the carbon atom is linked to an N, S, F, Cl, or O atom. In one embodiment said polar linkage is part of a carbonyl group and, in one embodiment, said polar linkage is part of an ester group. Preferred monomers comprising at least a heteroatom for the present invention are vinyl acetate, vinyl alcohol, methyl acrylate, ethyl acrylate, butyl acrylate, acrylic acid and salts formed therefrom, methacrylic acid and salts formed therefrom, maleic anhydride, glycidyl methacrylate and carbon monoxide.

A second component for the polymeric compositions of the present invention is a plasticizer or blend of plasticizers comprising at least one heteroatom, which plasticizer or blend of plasticizers is compatible with the copolymer of ethylene with at least another monomer comprising at least a heteroatom. The term “plasticizer comprising at least a heteroatom” includes all those plasticizers which comprise at least a C—X linkage in the molecule wherein X is not C or H. Said C—X linkage is in one embodiment a polar linkage. In one embodiment the carbon atom is linked to an N, S, F, Cl, or O atom. In one embodiment said polar linkage is part of a carbonyl group and, in one embodiment, said polar linkage is part of an ester group.

Suitable plasticizers for use in the polymeric compositions according to the present invention are described in WO 2005/049717 A2 incorporated herein by reference in its entirety and include citric acid esters, low molecular weight polyesters, polyethers, liquid rosin esters, aromatic sulfonamides, phthalates, benzoates, sucrose esters, derivatives of polyfunctional alcohols (where polyfunctional means having 2 or more hydroxyl groups), adipates, tartrates, sebacates, esters of phosphoric acid, fatty acids and diacids, fatty alcohols and diols, epoxidized vegetable oils etc and mixtures thereof. As already mentioned above, the different polarity of the different compatible plasticizers (measurable with any method known to those skilled in the art, for example water/octanol partition coefficient) can be used to tune the polarity of the polymeric matrix in order to provide a better match with the polarity of the perfume.

The polymeric compositions of the present invention in one embodiment are thermoplastic polymeric compositions. These can be manufactured by using any known process for manufacturing thermoplastic polymeric compositions and will typically comprise melting the polymer and then homogeneously blending the plasticizer and the perfume to form a homogeneous mass that is then cooled to obtain the polymeric composition. Among thermoplastic compositions preferred are those which have low melt temperature and viscosity and therefore may be processed as hot melts. In these hot-melt systems, the loss of perfume upon blending, as well as upon subsequent application in the molten state, is minimized.

Other optional components which can be used when the polymeric composition according to the present invention is a thermoplastic composition and is suitable for use as a perfumed hot-melt adhesive, are tackifying resins such as rosin derivatives, aliphatic resins, aromatic resins or mixed aliphatic-aromatic resins in order to further increase the adhesion capacity of the compositions of the present invention. Further optional ingredients such as other polymers or copolymers, fillers, crosslinkers, pigments, dyes, antioxidants and other stabilizers, etc can also be added to provide desired properties to the composition.

The polymeric compositions may also be prepared using a polymer solution, either as an intermediate or final step. Preparations of this type are well known to those skilled in the art and typically will comprise the steps of dissolving the selected polymer, plasticizer, and perfume in an effective solvent, and heating if necessary to prepare a solution or a gel. The solvent can then be eliminated by evaporation, thereby providing the polymer composition containing the perfume dispersed therein.

Alternatively, the polymeric compositions may be prepared in the form of an aqueous emulsion or dispersion. The techniques for obtaining aqueous emulsions or dispersions of polymers are well known to one of skill in the art. For example, the selected polymer, plasticizer, and perfume can be blended together as a thermoplastic material. The resulting melt can then be dispersed in water, at a temperature above its melting point, by mixing and surfactant and/or stabilizing systems known to those skilled in the art can be employed to stabilize the resultant emulsion or dispersion.

In certain alternative embodiments, a preformed aqueous polymeric dispersion or emulsion can be blended with the selected plasticizer and perfume. This can be accomplished by adding the ingredients directly to the polymeric dispersion or emulsion, or e.g. by forming an aqueous dispersion of the perfume and plasticizer and blending this with the polymeric dispersion or emulsion. Both procedures result in the formation of an aqueous dispersion of a polymeric composition. Water can be then eliminated by evaporation.

Alternatively, the copolymer can be directly formed in a water dispersion in the presence of the plasticizer and/or of the perfume. This process may involve the solution or dispersion of monomers or prepolymers in water that contains the dispersed perfume and/or plasticizer followed by initiation to form the polymeric dispersion. If required, the perfume or plasticizer can be alternatively added subsequently to produce a dispersed polymeric composition.

The polymeric compositions due to their rheology and their adhesion properties are particularly useful to be applied in the molten state onto a selected substrate, and directly adhered thereto. They can be applied, for example, to the inner surface of a container in a suitable position in order to suitably modify the headspace in the container by releasing the perfume to create a perfumed headspace. Such release is “passive”, i.e., it requires no human intervention or physical displacement. In certain embodiments, application to the inner surface of the container may be done during the manufacturing of the container. The polymeric composition may be applied using any suitable hot melt delivery system. These systems typically include a melting unit, which maintains the hot melt at a temperature that will provide a material of processable viscosity. The melting unit typically contains a pumping system capable of pumping the hot melt through a hose until it reaches the glue gun, or nozzle. The nozzle can have different geometries according to the desired application form of the glue (coatings, stripes, beads etc). In a typical embodiment, a slot nozzle can be used as the glue gun.

The term “substantially soluble” as applied to a material such as the fabric enhancer-non-copourable perfume composition or a preferred perfumed hot melt adhesive composition herein, means that at least about 80%, in one embodiment at least about 90% of the total amount of material referred to is soluble in the total amount of fabric enhancer present in the container.

### Olfactory Character of the Fabric Enhancer-Non-Copourable Perfume Composition

In certain embodiments, it is advantageous for the neat product odor (NPO) of the fabric enhancer to have a good “clean/fresh laundry” olfactory connotation that is distinct, for example, from a “fine fragrance” olfactory connotation. It is believed that this is due to the fact that consumers are likely to expect that the NPO of the products should act as a predictor for the expected smell of their laundry that has been washed with the product. In other words, the selection of olfactory character, in the consumer's mind, match the desired end use.

Therefore it is preferred that the fabric enhancer-non-copourable perfume herein should be formulated as a laundry perfume, focusing on volatile perfume raw materials (PRMs) and less on PRMs termed “residual” or “enduring” in the art. (The reverse being true for the fabric enhancer copourable perfume compositions further described hereinafter).

Suitable PRMs for use in the fabric enhancer-non-copourable perfume include, but are not limited to: aldehydic such as methylnonyl acetaldehyde, decyl aldehyde, or lauric aldehyde; floral such as PT bucinal, hexylcinnamic aldehyde, hexyl salicylate, benzyl acetate, or peonile; citrus such as orange oil, lemon oil, lemonile, gernyl nitrile, or dihydromyrcenol; fruity such as frutene or floracetate; green such as undecavertol, methylphenylcarbinyl actetate, beta gamma hexenol, or triplal; woody such as iso E super, methyl cedrylone, or patchouli; or musky such as habanolide or galaxolide.

Moreover, because the fabric enhancer-non-copourable perfume tends to “cover” the full product odor, it is preferred that the fabric enhancer-non-copourable perfume should itself comprise a fully formulated perfume as distinct from a simpler “accord” that blends with the product odor.

The term “substantially insoluble” as applied to a material such as the fabric enhancer-non-copourable perfume composition or a preferred perfumed hot melt adhesive composition herein, means that less than about 20%, in one embodiment less than about 10% of the total amount of material referred to is soluble in the total amount of fabric enhancer present in the container.

A “residual amount” as used herein is meant to include up to about 5% of the original amount by weight, in one embodiment up to about 3%, in one embodiment up to about 1%.

### Fabric Enhancer

The present products comprise a fabric enhancer. Typically the amount of the fabric enhancer is in accordance with the proportions by weight provided hereinabove in defining the fabric enhancer-non-copourable perfume composition. The fabric enhancer is typically provided in volumes of 1 liter, 1½ liter, 3 liter, or 5 liter in packages having sufficient internal capacity when fully loaded with the fabric enhancer to still have a headspace volume of at least about one milliliter, or even at least 5 milliliter.

In certain embodiments the fabric enhancers herein are pourable liquids or gels. Such fabric enhancers can have varying viscosities provided that they remain pourable. Suitable viscosities, measurement of viscosity, and thickeners/structurants are described in WO 05/012475, WO 05/059077 and WO 05/026303 which are incorporated herein by reference in their entirety. Briefly, the viscosity can be quantified by specifying a viscosity under a specified constant low stress as measured using, for example, a Carrimed CLS 100 Viscometer with a 40 mm stainless steel parallel plate having a gap of 500 microns. Unless indicated explicitly to the contrary, throughout the specification all stated viscosities are suitably measured at a shear rate of 21 s⁻¹ and at a temperature of 25° C.

In certain embodiments, the fabric enhancer composition is a pourable liquid, in one embodiment having a viscosity of less than about 1,500 mPa, less than about 1,000 mPa, or even less than about 500 mPa.

In certain embodiments, the fabric enhancer composition is a pourable gel, in one embodiment having a viscosity of from about 1,500 mPa to about 6,000 mPa, about 1,500 mPa to about 4,000 mPa, about 1,500 mPa to about 3,000 mPa, or even about 1,500 mPa to about 2,000 mPa.

Suitable fabric enhancers comprise at least one material copourable from the package with the balance of surfactants and/or carriers. The material is selected from (1) fabric enhancer-copourable perfume compositions, (2) fabric care additives; or (3) any combination thereof.

### (1) Fabric Enhancer-Copourable Perfume Composition

Suitable fabric enhancers herein include those comprising a fabric enhancer-copourable perfume composition. The fabric enhancer-copourable perfume composition can range in form and may be a perfume oil or a perfume emulsion, or can be a mixture comprising both a perfume oil and microparticles or microencapsulates of perfumery materials.

Suitable levels of fabric enhancer-copourable perfume composition comprise from about 0.0001 to about 25 wt %, in another embodiment from about 0.001 to about 20 wt %, in another embodiment from about 0.001 to about 10 wt %, in another embodiment from 0.05 to 1.0 wt % of the fabric enhancer composition.

In one embodiment, the fabric enhancer-copourable perfume composition comprises from 0.01% to about 2% of perfume microcapsules and/or from 0.03 to about 1% of an amine-assisted delivery system. In one embodiment, the fabric enhancer-copourable perfume composition comprises from 0.1% to about 1% of perfume microcapsules and/or from 0.06 to about 0.8% of an amine-assisted delivery system. In one embodiment, the fabric enhancer-copourable perfume composition comprises from 0.3% to about 0.9% of perfume microcapsules and/or from 0.12 to about 0.35% of an amine-assisted delivery system. Without wishing to be bound by theory, the amine-assisted delivery system can improve deposition and/or release of fabric enhancer-copourable PRMs from the free perfume and/or from the encapsulated perfume.

In one embodiment, the fabric enhancer-copourable perfume composition comprises a highly fabric substantive perfume.

In certain embodiments it may be advantageous for the fabric enhancer-copourable perfume composition to be fully mixed into the fabric enhancer to provide a solution, dispersion, or suspension. In certain such embodiments, a thickener may be used to improve storage stability. Preferred fabric enhancer-copourable perfume compositions comprise known perfumery materials, including pro-fragrances or pro-perfumes which are known in the art; see for example WO 00/00580, incorporated herein in its entirety by reference, which describes a beta-ketoester pro-fragrance with ethoxylated polyalkyleneimine and WO 99/46318, incorporated herein in its entirety by reference, which describes a silicone pro-fragrance, and U.S. Pat. No. 7,071,151 incorporated herein in its entirety by reference, which describes a light-triggered pro-fragrance.

Fully formulated perfumes, as distinct from simple accords or single perfumery compounds, are preferred. In certain embodiments the fabric enhancer-copourable perfume composition comprises a mixture of a liquid perfume formulation together with perfume microcapsules. Moreover, when using perfume microcapsules or amine-assisted perfume delivery, the invention includes embodiments in which no conventional liquid perfume formulations are added to the fabric enhancer.

Perfume microcapsules herein are any encapsulated perfumes having the form of discrete particles having sizes sufficiently small to be dispersed or suspended in the fabric enhancer compositions herein, so that they are pourable from the package along with the fabric enhancer composition. “Encapsulated” means that there will generally be present one or more coating layers enclosing the perfume. The perfume contained in the encapsulate can be in liquid or solid form and can be homogeneously or non-homogeneously distributed. Suitable particle sizes range from nanometer scale to micron scale and even to millimeter scale. Typical particle sizes range from 1 micron to 1 mm. In embodiments herein, encapsulated perfume leaves little or no visible residues on fabrics onto which it is deposited. In one embodiment, the microcapsule particle size ranges from about 1 micron to about 60 microns; in another embodiment from 5 micron to 30 micron.

In preferred embodiments perfume microcapsules have a measurable increase in deposition onto fabrics during laundering with the fabric enhancer, by virtue of chemical and/or physical mechanisms ranging from having a particle size suitable for being entrapped in fabrics by filtration, through to electrostatic attraction to (typically negatively charged) fabrics by virtue of having opposite net surface charge. In other embodiments, the perfume microcapsules are those which adhere to fabrics by virtue of tackiness, more specifically, having a work of adhesion consistent with tacky particles.

Suitable encapsulated or microencapsulated perfumes, i.e., perfume microcapsules, are described in U.S. 2004/0072719, U.S. Pat. No. 6,225,372, U.S. Pat. No. 6,359,031, U.S. Pat. No. 4,234,627, U.S. Pat. No. 3,516,941, U.S. Pat. No. 6,916,780, U.S. Pat. No. 4,919,841, U.S. Pat. No. 5,281,356, U.S. Pat. No. 5,281,357, U.S. Pat. No. 5,281,355 and under Fragrance Encapsulation in Kirk Othmer's Encyclopedia of Chemical Technology, which are incorporated herein by reference in their entirety. Suitable encapsulation systems include, but are not limited to waxes, aminoplasts, and emulsion polymerized systems. Coatings may be cationic, anionic or non-charged. In encapsulating perfumes for use in the fabric enhancer-copourable perfume composition, it is preferred both to (i) reduce or limit diffusion of perfume into the fabric enhancer and (ii) to enhance the fabric substantivity of the perfume, suitably as taught, for example, in Example 7 of the hereinbefore-referenced U.S. 2004/0072719 A1 which makes use of a specific cationic coating applied to perfume-loaded melamine-formaldehyde capsule slurries commercially available from Cytec Industries. Uniformly sized particles can be made by processes such as that described in U.S. Pat. No. 6,890,592, incorporated herein by reference in its entirety.

In other embodiments the fabric enhancer-copourable perfume composition comprises a mixture of a liquid perfume formulation together with an amino or polyamino-functional compound, which is optionally premixed with the liquid perfume. Such uses of polyamino or polyimine compounds to enhance fabric deposition of perfumes herein are collectively referred to as involving an “amine-assisted perfume delivery matrix”, or in alternate terms, “amine-assisted perfume”, or in alternate terms, “amine-assisted delivery system”, or in alternate terms, “amine-polymer-assisted delivery system” or in alternate terms, “APAD system”. In another embodiment, the polyamino or polyimine compound is added separately from the fabric enhancer-copourable perfume composition.

An amine-assisted perfume or perfume delivery system herein includes any perfumery compound or mixture of perfumery compounds having improved deposition on fabrics when laundered in the presence of the fabric enhancer, by virtue of a chemical and/or physical interaction between the perfumery compound or mixture of perfumery compounds and an organic amine or polyamine. The amine or polyamine can be added to the fabric enhancer separately from, or together with, perfumery compounds. In one embodiment the amine or polyamine is not in the form of a premix with perfumery compounds, it is added separately to the fabric enhancer. The amine or polyamine in one embodiment comprises at least one, in one embodiment a plurality of, primary and/or secondary and/or tertiary amine moieties. In preferred embodiments comprising amine-assisted perfumes or amine- or polyamine-assisted perfume delivery systems, the amine has a low vapor pressure and little or no inherent odor, for example having a normal boiling point of at least 200 deg. C. Amine-assisted perfumes herein generally comprise no enzymatic proteins as the essential polymeric aminofunctional perfume deposition enhancing material of such embodiments. Moreover amine-assisted perfumes herein generally comprise at most very low levels, in one embodiment less than 1 ppb, of malodorous low-boiling amine impurities, e.g., trimethylamine. In embodiments herein, the amine-assisted perfume leaves little or no visible residues on fabrics onto which it is deposited. Single and multiple APAD systems are contemplated. Without wishing to be bound by theory, it is believed that different APAD systems have improved efficacy as related to different perfumes. The combination of different APAD systems thereby improves the deposition and release of perfumes, particularly multiple component perfumes.

In one aspect, said APAD system comprises a polyalkylamine. In one aspect, said polyalkylamine comprises a polyethyleneamine or polyvinylamine. In one aspect, said polyethylenamine has a weight average molecular weight in daltons, as determined by dynamic light scattering (DLS) using a Malvern Zetasizer Nano-ZS, supplied by Malvern Instruments Ltd Enigma Business Park, Grovewood Road Malvern Worcestershire WR14 1XZ United Kingdom, of from about 500 to about 5,000,000, from about 1000 to about 1,000,000, or from about 7,000 to about 200,000.

In one aspect, said APAD system comprises a polymer which is made by polymerization of ethyleneimine. In another embodiment, the said polymer is water-soluble or partly water-soluble. In a particularly preferred embodiment, the APAD system comprises an amine-based polymer that is partly branched and contains primary, secondary and tertiary amines. Without wishing to be bound by theory, the combination of polar groups (amines) and hydrophobic groups (—CH₂CH₂—) imparts to the polymer adhesive characteristics and the ability to interact with a variety of organic materials, including but not limited to, perfume raw materials, perfume microcapsules, and other formulation components such as surfactants. For example, when the APAD system is formulated into a fabric enhancer, the APAD system may interact with carry-over surfactant from the wash process and/or cationic softener from the rinse process. Again without wishing to be bound by theory, such interactions may increase the deposition of other soluble or insoluble materials, such as perfume raw materials and/or perfume microcapsule particles. As such, the APAD system may impart improved softness or feel benefits as well as impart improved perfume delivery. Such improved perfume delivery can take the form of improved perfume deposition and/or release, which may be realized at any of the important consumer touch points, such as neat product odor, wet fabric odor, in-use room odor, or scent of laundry immediately out of the dryer or at any later dry fabric moment.

In yet another aspect of the present inventions, it was surprisingly found that APAD systems selected from polymers made from polymerization of ethyleneimine which have an average molecular weight in Daltons from about 20,000 to about 100,000 or from about 60,000 to about 80,000 provide best combination of both freshness and softness benefits. An example of such an APAD system includes polyethyleneimine polymers available from BASF that are known as Lupasol polymers or from Nippon Shokubai that are known as EPOMIN polymers. Examples include Lupasol WF and Lupasol HF and EPOMIN P-1000 or P-1050.

In another aspect of the present invention, the freshness and softness benefits are delivered via formulations containing free perfume and perfume microcapsules.

It has also been surprisingly found that the proper ratio of APAD to other polymers in the fabric enhancer formulation is critical to performance. In one embodiment, the ratio of polyethyleneimine polymers to other non-polyethyleneimine polymers in the formulation is from about 0.01 to about 10, in another embodiment from about 0.1 to about 2.0, in another embodiment from about 0.15 to 0.40. In another embodiment, the non-polyethyleneimine polymer is a cationic starch, for example, a cationic high amylose maize starch available from National Starch under the trade name CATO®. In another aspect, the polyamino or polyimine compound is neutralized or made acidic prior to addition of said polyamino or polyimine compound prior to combining with other fabric enhancer formulation ingredients. In yet another aspect, the polyamino or polyimine compound is in one embodiment diluted with water and neutralized to a pH from about 1 to 7, or from about 2 to 5, or from about 3 to 4 prior to combining with other fabric enhancer formulation ingredients, including fabric enhancer-copourable perfume composition.

In certain embodiments, the polyethylenamine can improve fabric softness, provide silky feel, and improve shape retention.

In embodiments of the invention comprising amine-assisted perfume delivery and/or perfume microcapsules, at least about 0.001, in another embodiment at least 0.01, in another embodiment, at least 0.1, in another embodiment at least 1 weight fraction of the fabric enhancer-copourable perfume composition is incorporated into a polyamine-assisted delivery matrix, a perfume microcapsule, or any combination thereof. Amine or polyamine assisted perfume systems for use as, or as part of, the fabric enhancer-copourable perfume composition are disclosed in the following patent documents, incorporated herein by reference in their entirety: U.S. 2003211960, U.S. 2003073607, U.S. 2004097397, U.S. 2003228992, U.S. 2003211963, U.S. 2004116320, U.S. 2005009727, U.S. 2005043205, U.S. Pat. No. 6,451,751, U.S. Pat. No. 6,511,948, U.S. Pat. No. 6,699,823, U.S. Pat. No. 6,790,815, U.S. 2005043208, U.S. Pat. No. 6,740,713, U.S. Pat. No. 6,764,986, WO 01/04084, and EP 1067117, which are incorporated herein in their entirety.

Suitable perfumery compounds for formulation of the fabric enhancer-copourable perfume composition, especially for embodiments which are, without wishing to be bound by theory, at least partially capable of deposition on fabrics so as to secure improved wet and/or dry fabric odor (perfumery compounds described as “enduring perfume” in U.S. Pat. No. 5,780,404 which is incorporated by reference in its entirety) include, but are not limited to, benzophenone, benzyl acetate, benzyl acetone, citronellol, citronellyl esters (acetate, formate, propionate), cis-3-hexenol, dimethyl benzyl carbinyl acetate, damascones (alpha, beta, delta), damascenone, damascenone total, eugenol, geraniol, geranyl esters (acetate, formate, propionate, butyrate, tiglate, phenyl acetate), geranyl nitrile, hexylcinnamic aldehyde, ionones (alpha, beta, gamma methyl), irones, linalool, lauric aldehyde, linalyl acetate, lilial, methyl dihydrojasmonate, nerol, phenyl ethyl acetate, phenyl ethyl esters (formate, acetate, isobutyrate, isovalerate, phenyl acetate), phenyl hexanol, ortho-tertiary-butylcyclohexyl acetate, para-tertiary-butylcyclohexyl acetate (cis and trans), rosalva, tetrahydrolinalool, undecylenic aldehyde, amylcinnamic aldehyde, amyl salicylate, anisic aldehyde, anethol, hydroxycitronellal:methyl anthranilate known commercially as “aurantiol”, benzyl alcohol, benzyl esters (butyrate, acetate, propionate, salicylate, benzoate), cis-jasmone, dihydroisojasmonate, flor acetate, frutene, gamma decalactone, helional, hydroxycitronellal, indol, nonalactone, methyl benzoate, methyl anthranilate, jasmolactone, undecalactone, cymal, dimethylbenzyl carbinol, floralozone, florhydral, lyral, mayol, majantol, mugetanol, oncidal, tetrahydromuguol, cis-3-hexenyl acetate, neobutenone, galaxolide, terpineol, heliotropin, vanillin, dihydromyrcenol, beta methyl naphtyl ketone, citronellyl nitrile, decyl aldehyde, mandaril, myrcenyl actetate, myrcene, methylnonyl acetaldehyde, methyl octyl acetaldehyde, nonyl aldehyde, octyl aldehyde, octyl alcohol, tetrahydro myrcenol, terpinyl acetate, alpha pinene, beta pinene, camphene, dipentene, eucalyptol, fenchyl acetate, fenchyl alcohol, terpinolene, carvone, methyl chavicol, methyl amyl ketone, methyl hexyl ketone, methyl salicylate, coumarin, iso E Super, vertofix, 1-(1,2,3,4,5,6,7,8-Octahydro-2,3,8,8-tetramethyl-2-naphthalenyl)ethanone known commercially as “iso gamma super”, ambrox, 1,5,5,9-Tetramethyl-13 -oxatricyclo(8.3.0.0(4,9))tridecane known commercially as “cetalox”, bacdanol, sanjinol, dartanol, javanol, cashmeran, caryophyllene, hydroxyambran, irone, isobutyl quinoline, lorysia, LRG 201, methyl cedrylone, ambrocenide, karanal, norlimbanol, orivone, polysantol, nirvanol, cis-3-hexenyl salicylate, diphenyl oxide, ligustral, methyl heptine carbonate, methyl octine carbonate, methyl phenyl carbinyl acetate, calone, floralozone, allyl amyl glycolate, allyl caproate, allyl cyclohxyl propionate, allyl heptoate, amyl acetate, amyl propionate, benzaldehyde, dodecalactone, ethyl acetate, ethyl acetoacetate, ethyl methylphenyl glycidate, ethyl-2-methyl propionate, ethyl-2-methyl butyrate, ethyl maltol, maltol, ethyl vanillin, ambrettolide, cashmeran, ethylene brassylate, exaltolide, muscenone delta, isoeugenol, tonalide, musk ketone, exaltex, exaltolide, indol, musk xylol, musk plus.

Other suitable perfumes for use in certain embodiments of fabric enhancer-copourable perfumes include perfumes having relatively high vapor pressures, specifically those having boiling points of greater than about 260° C.; high hydrophobicity, specifically those having ClogP (Octanol/Water) of greater than about 3.0; and low odor detection thresholds, specifically less than about 50 ppb; see U.S. Pat. No. 6,458,754; WO 99/55819 A; EP 1073705B, which are incorporated herein by reference in their entirety.

(2) Fabric Care Additives

Fabric enhancers herein include embodiments comprising fabric care additives. Suitable levels of fabric care additive in such embodiments are from about 0.0001% to about 20% by weight of the fabric enhancer, more typically from about 0.1% to about 5 wt %. Fabric care additives are materials which help retain or improve fabric properties and/or fabric comfort properties, especially of colored fabrics. Fabric care additives include, but are not limited to, fabric shape retention aids, fabric softeners or conditioners, antistatic agents, humectants, fabric skin feel improvers, wrinkle reducers, antipilling agents, dye fixatives, and the like.

Suitable fabric care additives include, but are not limited to cationic fabric softener agents (such as a quaternary ammonium fabric-softening agent,), cationic gums such as cationic hydroxyethylcellulose, silicone polymers or copolymers such as aminosilicones commercially available from General Electric, Dow Corning and other suppliers, chlorine scavengers, polyethylene microbeads, dye fixatives such as polyvinylpyridine N-oxide, dye transfer inhibitors, or any combination thereof

In certain embodiments, the fabric enhancers comprise a dye fixative material. Suitable dye fixatives are described on page 35 of WO 00/27958 which is incorporated by reference and are commercially marketed by Ciba and Clariant.

In certain embodiments, the fabric enhancer comprises a silicone polymer or a blend of silicones, e.g., a blend comprising at least one aminofunctional silicone. Suitable aminofunctional silicones are described, for example, in WO 05/007790, WO 04/046452, WO 04/042136, WO 04041987, and WO 04/041912 which are incorporated by reference in their entirety. Coacervate phase forming polymers may be added, as described in WO 04/041983. Other suitable aminosilicones may be used, such materials being commercially available from Dow Corning, Wacker Chemie and other suppliers. Silicone copolymers or blends thereof, especially those containing non-yellowing aminosilicones, can improve fabric softness, provide silky feel, and improve shape retention.

In certain embodiments, the fabric enhancer comprises a cationic silicone polymer. Suitable cationic silicone polymers are described, for example, in U.S. Pat. No. 6,903,061, which is incorporated in its entirety by reference. In certain such embodiments, the cationic silicone polymer comprises one or more polysiloxane units, in one embodiment polydimethylsiloxane units of formula —{(CH₃)₂SiO}ₙ— having a degree of polymerization, n, of from 50 to 200 and organosilicon-free units comprising at least one diquaternary unit. In certain preferred embodiments, the selected cationic silicone polymer has from 0.50 to 1.0 weight fraction of said organosilicon-free units selected from N,N,N′,N′-tetramethyl-1,6-hexanediammonium units.

The selected cationic silicone polymer can also contain from about 0.0 to 0.20 weight fraction, in certain embodiments a non-zero amount, of the total of organosilicon-free units of —NHCH(CH₃)CH₂O(AO)ₐCH₂CH(CH₃)NH— units wherein AO represents ethyleneoxy, propyleneoxy, butyleneoxy and mixtures thereof and a is from 5 to 70.

The selected cationic silicone polymer can also contain from about 0.0, in certain embodiments a non-zero amount to 0.20 weight fraction, of the total of organosilicon-free units of —NR₃⁺ wherein R is alkyl, hydroxyalkyl or phenyl. These units can be thought of as end-caps.

Moreover the selected cationic silicone polymer generally contains anions, selected from inorganic and organic anions, in one embodiment selected from saturated and unsaturated C₁-C₂₀ carboxylates and mixtures thereof, to balance the charge of the quaternary moieties, thus the cationic silicone polymer also comprises such anions in a quaternary charge-balancing proportion.

Conceptually, the selected cationic silicone polymers herein can helpfully be thought of as non-crosslinked or “linear” block copolymers including non-fabric-substantive but surface energy modifying “loops” made up of the polysiloxane units, and fabric-substantive “hooks”.

In certain embodiments, the fabric enhancer may comprise a polymeric dye transfer inhibiting agent. Polymeric dye transfer inhibiting agents are known in the art for reducing or preventing dye-transfer during the laundering process. Polymeric dye transfer inhibiting agents useful herein include polyvinylpyrrolidone and copolymers thereof.

In certain alternative embodiments, the fabric enhancer may comprise, as a fabric care additive, a fabric-softening agent (“FSA”). In certain such embodiments, the compositions contain from at least about 1%, alternatively at least about 2%, alternatively at least about 3%, alternatively at least about at least about 5%, alternatively at least about 10%, and alternatively at least about 12%, by weight of the composition. The composition may typical comprise maximum levels of FSA of about less than about 90%, alternatively less than about 40%, alternatively less than about 30%, alternatively less than about 20%, by weight of the composition.

In one embodiment of the invention, the FSA is a quaternary ammonium compound suitable for softening fabric in a rinse step. In one embodiment, the FSA is formed from a reaction product of a fatty acid and an alkanolamines (consistent with terminology below) obtaining mixtures of mono-, di-, and, in one embodiment, triester compounds, in a second embodiment, free or essentially free of a triester compounds. In another embodiment, the FSA comprises one or more softener quaternary ammonium compounds such, but not limited to, as a monoalkylquaternary,ammonium compound, monoester quaternary ammonium compound, a monoamido quaternary ammonium compound, a dialkylquaternary ammonium compound, a diamido quaternary compound, a diester quaternary ammonium compound, or combinations thereof.

In one aspect of the invention, the FSA comprises a diester quaternary ammonium (hereinafter “DQA”) compound composition. In certain embodiments of the present invention, the DQA compounds compositions also encompasses a description of diamido FSAs and FSAs with mixed amido and ester linkages as well as the aforementioned diester linkages, all herein referred to as DQA.

A first type of DQA (“DQA (1)”) that could be suitable as a FSA in the present invention includes a compound comprising the formula:

{R4-m-N+-[(CH2)n-Y—R1]m}X—

wherein each R substituent is either hydrogen, a short chain C₁-C₆, in one embodiment C₁-C₃ alkyl or hydroxyalkyl group, e.g., methyl, ethyl, propyl, hydroxyethyl, hydroxypropyl, and the like, poly (C₂₋₃ alkoxy), in one embodiment polyethoxy, group, benzyl, or mixtures thereof; each m is 2 or 3; each n is from 1 to about 4, in one embodiment 2; each Y is —O—(O)C—, —C(O)—O—, —NR—C(O)—, or —C(O)—NR— and it is acceptable for each Y to be the same or different; the sum of carbons in each R¹, plus one when Y is —O—(O)C— or —NR—C(O)—, is C₁₂-C₂₂, in one embodiment C₁₄-C₂₀, with each R¹ being a hydrocarbyl, or substituted hydrocarbyl group; it is acceptable for R¹ to be unsaturated or saturated and branched or linear and in one embodiment it is linear; it is acceptable for each R¹ to be the same or different and in one embodiment these are the same; and X⁻ can be any softener-compatible anion, in one embodiment, chloride, bromide, methylsulfate, ethylsulfate, sulfate, phosphate, and nitrate, in one embodiment chloride or methyl sulfate. Preferred DQA compounds are typically made by reacting alkanolamines such as MDEA (methyldiethanolamine) and TEA (triethanolamine) with fatty acids. Some materials that typically result from such reactions include N,N-di(acyl-oxyethyl)-N,N-dimethylammonium chloride or N,N-di(acyl-oxyethyl)-N,N-methylhydroxyethylammonium methylsulfate wherein the acyl group is derived from animal fats, unsaturated, and polyunsaturated, fatty acids, e.g., tallow, hardened tallow, oleic acid, and/or partially hydrogenated fatty acids, derived from vegetable oils and/or partially hydrogenated vegetable oils, such as, canola oil, safflower oil, peanut oil, sunflower oil, corn oil, soybean oil, tall oil, rice bran oil, palm oil, etc. Non-limiting examples of suitable fatty acids are listed in U.S. Pat. No. 5,759,990 at column 4, lines 45-66. In one embodiment the FSA comprises other actives in addition to DQA (1) or DQA. In yet another embodiment, the FSA comprises only DQA (1) or DQA and is free or essentially free of any other quaternary ammonium compounds or other actives. In yet another embodiment, the FSA comprises the precursor amine that is used to produce the DQA.

In another aspect of the invention, the FSA comprises a compound, identified as DTDMAC comprising the formula:

[R4-m-N(+)-R1m]A-

wherein each m is 2 or 3, each R¹ is a C₆-C₂₂, in one embodiment C₁₄-C₂₀, but no more than one being less than about C₁₂ and then the other is at least about 16, hydrocarbyl, or substituted hydrocarbyl substituent, in one embodiment C₁₀-C₂₀ alkyl or alkenyl (unsaturated alkyl, including polyunsaturated alkyl, also referred to sometimes as “alkylene”), in one embodiment C₁₂-C₁₈ alkyl or alkenyl, and branch or unbranched. In one embodiment, each R is H or a short chain C₁-C₆, in one embodiment C₁-C₃ alkyl or hydroxyalkyl group, e.g., methyl, ethyl, propyl, hydroxyethyl, and the like, benzyl, or (R²O)₂₋₄H where each R² is a C₁₋₆ alkylene group; and A⁻ is a softener compatible anion, in one embodiment, chloride, bromide, methylsulfate, ethylsulfate, sulfate, phosphate, or nitrate; in one embodiment chloride or methyl sulfate. Examples of these FSAs include dialkydimethylammonium salts and dialkylenedimethylammonium salts such as ditallowdimethylammonium chloride and ditallowdimethylammonium methylsulfate. Examples of commercially available dialkyl(ene)dimethylammonium salts usable in the present invention are di-hydrogenated tallow dimethyl ammonium chloride and ditallowdimethyl ammonium chloride available from Degussa under the trade names Adogen® 442 and Adogen® 470 respectively. In one embodiment the FSA comprises other actives in addition to DTDMAC. In yet another embodiment, the FSA comprises only compounds of the DTDMAC and is free or essentially free of any other quaternary ammonium compounds or other actives.

In one embodiment, the FSA comprises an FSA described in U.S. Pat. Pub. No. 2004/0204337 A1, published Oct. 14, 2004 to Corona et al., from paragraphs 30-79.

In another embodiment, the FSA is one described in U.S. Pat. Pub. No. 2004/0229769 A1, published Nov. 18, 2005, to Smith et al., on paragraphs 26-31; or U.S. Pat. No. 6,494,920, at column 1, line 51 et seq. detailing an “esterquat” or a quaternized fatty acid triethanolamine ester salt.

In one embodiment, a dispersion polymer is added to the composition. Such dispersion polymers include cationic and anionic dispersion polymers. In one embodiment, non-acrylamide based polymers are contemplated. An exemplary cationic dispersion polymer is made by Ciba® under the trade name Rheovis® CDE. Without being bound by theory, it is believed that the dispersion polymer suspends microcapsules present within the composition. Moreover, these dispersion polymers also function as APAD systems.

Other Adjuncts

Fabric enhancers herein may comprise small amounts of conventional surfactants, at levels of from about 1 to about 80 wt. %, in one embodiment from about 1 to about 50 wt. %. In an alternative embodiment, fabric enhancers may comprise less than 1% surfactant, in another embodiment less than 0.5% surfactant, in another embodiment less than 0.01% surfactant, in another embodiment be free of surfactant. Surfactants may be of anionic, nonionic, zwitterionic, amphoteric or cationic or any compatible mixtures thereof.

The fabric enhancers according to the present invention also contain an aqueous carrier; in certain embodiments the carrier may be thickened or non-thickened, and in certain embodiments the carrier may further include a conventional hydrotrope. Generally the amount of the aqueous carrier employed in the compositions herein will be relatively large. In one embodiment, the compositions of the present invention comprise from about 40% to about 80% of an aqueous liquid carrier. The most cost effective type of aqueous, non-surface active liquid carrier is, of course, water itself. Accordingly, the aqueous, non-surface active liquid carrier component will generally be mostly, if not completely, comprised of water. Other water-miscible carriers, such as alkanols, diols, polyols, ethers, amines, alkanolamines, and similar solvents may be added to fabric enhancer as co-solvents or stabilizers. Accordingly, the aqueous liquid carrier component of the fabric enhancer products herein, including organic solvents if present, will generally comprise water present in concentrations ranging from about 30% to 93%, in one embodiment from about 35% to about 50%, by weight of the composition. In certain embodiments, the level of any non-water solvent will be minimized, e.g., not more than about 10%, in one embodiment not more than about 5%, in one embodiment not more than about 1% of non-water solvents will be present in the fabric enhancers.

In one embodiment, the composition of the present invention may comprise any one or more adjunct ingredients. In yet another embodiment, the composition of the present invention may be free or essentially free of any one or more adjunct ingredients. The term “adjunct ingredients” may include: a dispersing agent, stabilizer, pH control agent, metal ion control agent, colorant, brightener, dye, odor control agent, pro-perfume, cyclodextrin, solvent, soil release polymer, preservative, antimicrobial agent, chlorine scavenger, enzyme, anti-shrinkage agent, fabric crisping agent, spotting agent, anti-oxidant, anti-corrosion agent, bodying agent, drape and form control agent, smoothness agent, static control agent, wrinkle control agent, sanitization agent, disinfecting agent, germ control agent, mold control agent, mildew control agent, antiviral agent, anti-microbial, drying agent, stain resistance agent, soil release agent, malodor control agent, fabric refreshing agent, chlorine bleach odor control agent, dye fixative, dye transfer inhibitor, color maintenance agent, color restoration/rejuvenation agent, anti-fading agent, whiteness enhancer, anti-abrasion agent, wear resistance agent, fabric integrity agent, anti-wear agent, and rinse aid, UV protection agent, sun fade inhibitor, insect repellent, anti-allergenic agent, enzyme, flame retardant, water proofing agent, fabric comfort agent, water conditioning agent, shrinkage resistance agent, stretch resistance agent, calcium chloride, mica, and combinations thereof. In one embodiment, the composition comprises an adjunct ingredient up to about 2% by weight, in another embodiment up to about 10%, in another embodiment, up to about 20% of the composition.

Other embodiments are possible within the spirit and scope of the invention. Such embodiments include products having a cap or over-cap which can be used as a measuring device. It is possible to include a separate portion of fabric enhancer-non-copourable perfume composition which is affixed to such a measuring device. It is furthermore possible for the invention to include multi-compartment, e.g., dual compartment, bottles, with the fabric enhancer-non-copourable perfume composition present to perfume the headspace of one or both compartments. It is possible to use the invention in conjunction with fabric enhancer products which are fully transparent, hazy or opaque, e.g., as a result of incorporating an opacifier or pearlescent agent, or in cases where the fabric enhancer is inherently hazy. It is moreover possible to use the invention in conjunction with fabric enhancer products comprising more than one fluid phase, such as a so-called “split phase” fluid.

The term “ambient storage temperature” as used herein is in the range from about 0° C. to about 50° C., in one embodiment from about 5° C. to about 40° C., in one embodiment from about 10° C. to about 30° C., suitably about 25° C.

The term “copourable” as used herein means that the material referred to pours out of the package along with the fabric enhancer at ambient temperature. Examples of copourable materials include those which are soluble in, or suspendable in, the fabric enhancer. Preferred copourable perfumes include perfumes that are emulsifiable in the fabric enhancer, soluble in the fabric enhancer, or suspendable as small particles (e.g., having size from nanometer-scale to about 2 millimeters) in the composition as determined at ambient storage temperature.

The term “fluid” as used herein is meant to include compositions that are pourable at ambient temperature. Such compositions include, but are not limited to, liquids and gels.

The term “headspace” as used herein refers to an accessible headspace and is meant to include the vapor located above the fabric enhancer in a package or container that enables the odor of the contents of the package or container to be detected by the user. In one embodiment the headspace is located in the package at a location that suitable for olfactory sampling by a consumer on opening the closure of the package. A typical headspace volume is from 5% to 10%, suitably 8% v/v (volume/volume)—in other words, a package suitably comprises 92% by volume of fabric enhancer and 8% headspace by volume.

The term “tackifier” or “tackifier resin” herein is as used in the art of adhesives, more specifically hot-melt adhesives. See U.S. Pat. No. 4,623,698. A tackifier is optionally added when making the fabric enhancer-non-copourable perfume composition, in order to improve its tackiness. Tackifiers are available commercially from suppliers such as Dupont under the ELVAX tradename or from Eastman under the FORALYN tradename.

### EXAMPLES

The following are non-limiting examples of the fabric conditioning compositions of the present invention.

Examples of fabric enhancer-copourable compositions:

| Ingredients | A | B | C | D | E | F | G | H |
|---|---|---|---|---|---|---|---|---|
| FSA^{a} | 16 | 16 | 14 | 18 | 10 | 8 | 6 | 12 |
| Starch^{b} | 1.0 | 1.4 | 0.8 | 2.0 | 1.0 | 0.5 | 0.3 | 0.0 |
| Phase Stabilizing | 0.1 | 0.0 | 0.1 | 0 | 0 | 0.05 | 0.0 | 0.00 |
| Polymer^{c} | | | | | | | | |
| Calcium Chloride | 0.11 | 0.15 | 0.17 | 0.31 | 0.08 | 0.10 | 0.03 | 0.09 |
| DTPA^{d} | 0.017 | 0.015 | 0.019 | 0.019 | 0.015 | 0.007 | 0.004 | 0.007 |
| Preservative (ppm)^{e} | 5 | 5 | 5 | 5 | 5 | 5 | 5 | 5 |
| Antifoam^{f} | 0.015 | 0.018 | 0.015 | 0.015 | 0.018 | 0.015 | 0.015 | 0.012 |
| Colorant (ppm)*** | 250 | 300 | 170 | 350 | 100 | 150 | 50 | 200 |
| Ammonium Chloride | 0.14 | 0.09 | 0.10 | 0.12 | 0.07 | 0.10 | 0.05 | 0.11 |
| HCl (pH modifier)**** | 0.012 | 0.009 | 0.012 | 0.006 | 0.014 | 0.012 | 0.020 | 0.008 |
| Structurant^{g} | 0.01 | 0 | 0.01 | 0.01 | 0.01 | 0.01 | 0 | 0 |
| Neat Perfume | 0.2 | 0.5 | 0.8 | 1.2 | 1.0 | 0.8 | 0.5 | 0.9 |
| Encapsulated Perfume | 0.9 | 1.4 | 0.6 | 1.0 | 0.5 | 0.7 | 1.2 | 0.3 |
| Polyethyleneimine | 0.2 | 0.1 | 0.3 | 0.1 | 0 | 0.25 | 0.15 | 0.2 |
| (25,000 MW average) | | | | | | | | |
| Liquid carrier*^{h} | | | | | | | | |
| PAD matrix in the form of | 0.6 | 0.7 | 0 | 0 | 0 | 0.4 | 0.5 | 0 |
| a Hot Melt** with | | | | | | | | |
| Perfume (g) | | | | | | | | |

*Balance
**The products above are packaged in a package comprising a container comprising a cap. The packaging in one aspect comprises the aforementioned PAD matrix system in the form of a Hot Melt adhesive. The PAD in form of hot melt adhesive in above examples is placed under or in close proximity to said cap.
***Colorant examples are described in U.S. Pat. No. 6,797,688 B2 col. 32 lines 5-10.
****pH modifiers is described in U.S. Pat. No. 6,797,688 B2 col. 6 lines 63-67 and col. 7 lines 1-5.
^{a}N,N-di(tallowoyloxyethyl)-N,N-dimethylammonium chloride.
^{b}Cationic high amylose maize starch available from National Starch under the trade name CATO ®.
^{c}Copolymer of ethylene oxide and terephthalate having the formula described in U.S. Pat. No. 5,574,179 at col.15, lines 1-5, wherein each X is methyl, each n is 40, u is 4, each R1 is essentially 1,4-phenylene moieties, each R2 is essentially ethylene, 1,2-propylene moieties, or mixtures thereof.
^{d}Diethylenetriaminepentaacetic acid.
^{e}KATHON ® CG available from Rohm and Haas Co. “PPM” is “parts per million.”
^{f}Silicone antifoam agent available from Dow Corning Corp. under the trade name DC2310.
^{g}Hydrophobically-modified ethoxylated urethane available from Rohm and Haas under the tradename Aculan 44.
^{h}Primarily water as described in U.S. Pat. No. 6,797,688 B2 at col. 30, lines 1-10.

Examples of fabric enhancer-non-copourable perfume composition:

| | AA | BB | CC |
|---|---|---|---|
| Polymerⁱ | 25 | 35 | 40 |
| Plasticizer^{j} | 19.5 | 10 | 20 |
| Tackifier^{k} | 10 | 5 | 14 |
| Neat Perfume | 45 | 48 | 35 |
| Colorant | 0.5 | 2.0 | 1.0 |

ⁱcommercially from suppliers such as Dupont under the ELVAX tradename
^{j}commercially from suppliers such Eastman under the Foral tradename
^{k}commercially from suppliers such as Eastman under the FORALYN tradename

Additional examples of fabric enhancer-copourable compositions

| Ingredients | I | J | K | L | M | N | O | P | Q |
|---|---|---|---|---|---|---|---|---|---|
| FSA^{a} | 16 | 16 | 14 | 18 | 10 | 8 | 6 | 12 | 18 |
| Starch^{b} | 0.8 | 0.8 | 0.3 | 0 | 1.4 | 1.5 | 0 | 0.8 | 0 |
| Phase Stabilizing | 0.1 | 0.0 | 0.1 | 0 | 0 | 0.05 | 0.0 | 0.0 | 0 |
| Polymer^{c} | | | | | | | | | |
| Calcium Chloride | 0.11 | 0.15 | 0.17 | 0.31 | 0.08 | 0.10 | 0.03 | 0.09 | 0.31 |
| DTPA^{d} | 0.017 | 0.015 | 0.019 | 0.019 | 0.015 | 0.007 | 0.004 | 0.007 | 0.019 |
| Preservative (ppm)^{e} | 5 | 5 | 5 | 5 | 5 | 5 | 5 | 5 | 5 |
| Antifoam^{f} | 0.015 | 0.018 | 0.015 | 0.015 | 0.018 | 0.015 | 0.015 | 0.012 | 0.015 |
| Colorant (ppm)*** | 250 | 300 | 170 | 350 | 100 | 150 | 50 | 200 | 350 |
| Ammonium Chloride | 0.14 | 0.09 | 0.10 | 0.12 | 0.07 | 0.10 | 0.05 | 0.11 | 0.12 |
| HCl (pH modifier)**** | 0.012 | 0.009 | 0.012 | 0.006 | 0.014 | 0.012 | 0.020 | 0.008 | 0.006 |
| Structurant^{g} | 0.01 | 0 | 0.01 | 0.01 | 0.01 | 0.01 | 0 | 0 | 0.01 |
| Neat Perfume | 0.2 | 0.5 | 0.8 | 1.2 | 1.0 | 0.8 | 0.5 | 0.9 | 1.6 |
| Encapsulated Perfume | 0.48 | 0.20 | 0.11 | 0.31 | 0.07 | 0.1 | 0.15 | 0.12 | 0.1 |
| Polyethyleneimine | 0 | 0 | 0.11 | 0 | 0.20 | 0 | 0 | 0 | 0 |
| (10,000 MW average)^{j} | | | | | | | | | |
| Polyethyleneimine | 0.20 | 0.18 | 0.11 | 0.19 | 0 | 0.23 | 0 | 0 | 0.21 |
| (70,000 MW average)^{k} | | | | | | | | | |
| Rheovis CDE^{l} | 0 | 0 | 0 | 0 | 0 | 0 | 0.3 | 0 | 0.3 |
| Silicone^{m} | 0 | 0 | 2.4 | 0 | 0 | 0 | 0 | 2.0 | 0 |
| PAM/MAPTACⁿ | 0 | 0 | 0 | 0.17 | 0 | 0 | 0 | 0.15 | 0 |
| Liquid carrier*^{h} | | | | | | | | | |
| PAD matrix in the form of | 0 | 0.4 | 0.3 | 0 | 0 | 0 | 0.5 | 0 | 0 |
| a Hot Melt** with | | | | | | | | | |
| Perfume (g) | | | | | | | | | |

*Balance
**The products above are packaged in a package comprising a container comprising a cap. The packaging in one aspect comprises the aforementioned PAD matrix system in the form of a Hot Melt adhesive. The PAD in form of hot melt adhesive in above examples is placed under or in close proximity to said cap.
***Colorant examples are described in U.S. Pat. No. 6,797,688 B2 col. 32 lines 5-10.
****pH modifiers is described in U.S. Pat. No. 6,797,688 B2 col. 6 lines 63-67 and col. 7 lines 1-5.
^{a}N,N-di(tallowoyloxyethyl)-N,N-dimethylammonium chloride.
^{b}Cationic high amylose maize starch available from National Starch under the trade name CATO ®.
^{c}Copolymer of ethylene oxide and terephthalate having the formula described in U.S. Pat. No. 5,574,179 at col.15, lines 1-5, wherein each X is methyl, each n is 40, u is 4, each R1 is essentially 1,4-phenylene moieties, each R2 is essentially ethylene, 1,2-propylene moieties, or mixtures thereof.
^{d}Diethylenetriaminepentaacetic acid.
^{e}KATHON ® CG available from Rohm and Haas Co. “PPM” is “parts per million.”
^{f}Silicone antifoam agent available from Dow Corning Corp. under the trade name DC2310.
^{g}Hydrophobically-modified ethoxylated urethane available from Rohm and Haas under the tradename Aculan 44.
^{h}Primarily water as described in U.S. Pat. No. 6,797,688 B2 at col. 30, lines 1-10.
^{j}EPOMIN ® SP-200 available from Nippon Shokubai.
^{k}EPOMIN ® P-1050 available from Nippon Shokubai.
^{l}Rheovis CDE available from CIBA.
^{m}DC1664 Silicone available from Dow Corning

What is claimed is:

1. A fabric enhancer product comprising
(a) a package comprising
(1) a container; and
(2) a closure;
(b) a fabric enhancer comprising a material copourable from the package with the fabric enhancer, wherein the material is selected from:
(1) a fabric enhancer-copourable perfume composition;
(2) a fabric care additive;
and
(3) any combination thereof;
(c) a headspace; and
(d) a fabric enhancer-non-copourable perfume composition;
wherein the pH of the fabric enhancer is less than about 7.

2. A fabric enhancer product of claim 1, wherein the release of perfume from the fabric enhancer-non-copourable perfume composition is passive, and wherein the package comprises a pour spout having dimensions sufficient for the fabric enhancer to pour from the package without application of a squeezing pressure.

3. A fabric enhancer product of claim 2, having a weight ratio of perfume in the fabric enhancer-copourable perfume composition to perfume in the fabric enhancer-non-copourable perfume composition of from about 0:1 to about 1:0.00001.

4. A fabric enhancer product of claim 1, wherein the fabric enhancer-non-copourable perfume composition is affixed to an internal portion of the package, provided that when the fabric enhancer-non-copourable perfume composition is meltable, the pouring temperature of the fabric enhancer-non-copourable perfume composition is at least about 5° C. above the ambient storage temperature.

5. A fabric enhancer product of claim 1, wherein the package further comprises a transition component.

6. A fabric enhancer product of claim 5, wherein the fabric enhancer-non-copourable perfume composition is located in the transition component.

7. A fabric enhancer product claim 1, wherein the fabric enhancer-non-copourable perfume composition is a solidified perfumed hot-melt adhesive.

8. A fabric enhancer product of claim 7, wherein the hot-melt adhesive comprises at least one plasticizer, at least one tackifier, or any combination thereof.

9. A fabric enhancer product of claim 8, wherein the hot-melt adhesive composition is insoluble in the fabric enhancer.

10. A fabric enhancer product of claim 1, wherein the fabric enhancer-non-copourable perfume composition is affixed to a solid having dimensions larger than the outlet of the package and floatable in the fabric enhancer; provided that when the fabric enhancer-non-copourable perfume composition is meltable, the pouring temperature thereof is at least 5° C. above the ambient storage temperature.

11. A fabric enhancer product of claim 1, wherein the fabric enhancer-non-copourable perfume composition is located in the closure

12. A claim according to claim 11 wherein the fabric enhancer product further comprises an amine-assisted delivery system.

13. A fabric enhancer product of claim 1, comprising
(a) a package comprising
(1) a container; and
(2) a closure;
(b) a fabric enhancer pourable at ambient storage temperature and comprising at least one material copourable from the package with the fabric enhancer, wherein the material comprises a fabric care additive;
(c) a headspace; and
(d) a fabric enhancer-non-copourable perfume composition.

14. A fabric enhancer product of claim 13, wherein the fabric care additive is selected from silicone polymers, cationic fabric softeners, dye fixatives, dye transfer inhibitors, cationic gums, and mixtures thereof.

15. A fabric enhancer product of claim 1, wherein the fabric enhancer non-copourable perfume composition is self-adhering.

16. A fabric enhancer product of claim 1, wherein the fabric enhancer non-copourable perfume composition further comprises an adhesive for affixing the fabric enhancer-non-copourable perfume composition to the package.

17. A fabric enhancer product of claim 14, wherein the amount of perfume in the fabric enhancer-non-copourable perfume composition is from about 1 to 80 wt % of the fabric enhancer-non-copourable perfume composition, the balance of the fabric enhancer-non-copourable perfume composition comprising thermoplastic polymers, plasticizers, tackifiers, or any combination thereof.

18. A fabric enhancer product of claim 1, wherein at least one of the fabric enhancer-copourable perfume composition and the fabric enhancer-non-copourable perfume composition comprises at least five components.

19. A fabric enhancer product of claim 1, wherein the fabric enhancer-copourable perfume composition has an olfactory character matching that of the fabric enhancer-non-copourable perfume composition.

20. A fabric enhancer product of claim 1, wherein the fabric enhancer-copourable perfume composition has an olfactory character differing from that of the fabric enhancer-non-copourable perfume composition.

21. A fabric enhancer product of claim 1, wherein the fabric enhancer-copourable perfume composition comprises:
a.) from about 0.01% to about 20%, from about 0.03% to about 15%, from about 0.05% to about 10%, or from about 0.1% to about 5% of a neat perfume comprising, based on weight of said neat perfume:
(i) from about 1% to about 30%, from about 2% to about 20%, from about 3% to about 15%, or from about 4% to about 10% of a perfume raw material having a boiling point less than or equal to 250° C. and a ClogP less than or equal to 2.5;
(ii) from about 5% to about 70%, from about 10% to about 60%, from about 15% to about 50%, or from about 20% to about 40% of a perfume raw material having boiling point less than or equal to 250° C. and a ClogP greater than 2.5;
(iii) from about 1% to about 30%, from about 2% to about 20%, from about 3% to about 15%, or from about 4% to about 10% of a perfume raw material having boiling point greater than 250° C. but less than or equal to 280° C.; and
b.) from about 0.01% to about 20%, from about 0.03% to about 15%, from about 0.5% to about 10%, or from about 0.1% to about 5% of a perfume delivery system comprising a perfume microcapsule; and
optionally a fabric enhancer-noncopourable perfume composition comprising:
from about 1% to about 80%, from about 5% to about 70%, from about 10% to about 60% of a perfume comprising, based on weight of said neat perfume:
(i) from 0 to 100%, from about 1% to about 30%, from about 2% to about 20%, from about 3% to about 15%, or from about 4% to about 10% of a perfume raw material having a boiling point less than or equal to 250° C. and a ClogP less than or equal to 2.5;
(ii) from 0 to 100%, from about 5% to about 70%, from about 10% to about 60%, from about 15% to about 50%, or from about 20% to about 40% of a perfume raw material having boiling point less than or equal to 250° C. and a ClogP greater than 2.5; and
(iii) from about 0 to about 100, from about 1% to about 30%, from about 2% to about 20%, from about 3% to about 15%, or from about 4% to about 10% of a perfume raw material having boiling point greater than 250° C. but less than or equal to 280° C.

22. A fabric enhancer product of claim 1, wherein the fabric enhancer-copourable perfume composition comprises:
a.) from about 0.01% to about 20%, from about 0.03% to about 15%, from about 0.05% to about 10%, or from about 0.1% to about 5% of a neat perfume comprising, based on weight of said neat perfume:
(i) from about 2% to about 40%, from about 4% to about 30%, or from about 8% to about 20% of a perfume raw material having a boiling point less than or equal to 250° C. and a ClogP less than or equal to 2.5;
(ii) from about 4% to about 60%, from about 7% to about 50%, from about 10% to about 40%, or from about 15% to about 30% of a perfume raw material having boiling point less than or equal to 250° C. and a ClogP greater than 2.5; and
(iii) from about 1% to about 20%, from about 1% to about 15%, from about 2% to about 10%, or from about 3% to about 6% of a perfume raw material having boiling point greater than 250° C. but less than or equal to 280° C.
b.) from about 0.01% to about 20%, from about 0.03% to about 15%, from about 0.5% to about 10%, or from about 0.1% to about 5% of a perfume delivery system comprising a perfume microcapsule; and
c.) from about 0.03% to about 2%, from about 0.06% to about 0.8%, from about 0.12% to about 0.35% of a perfume delivery system comprising an amine-assisted delivery system; and
optionally a fabric enhancer-noncopourable perfume composition comprising:
from about 1% to about 80%, from about 5% to about 70%, from about 10% to about 60% of a perfunne comprising, based on weight of said neat perfume:
(i) from 0 to 100%, from about 1% to about 30%, from about 2% to about 20%, from about 3% to about 15%, or from about 4% to about 10% of a perfume raw material having a boiling point less than or equal to 250° C. and a ClogP less than or equal to 2.5;
(ii) from 0 to 100%, from about 5% to about 70%, from about 10% to about 60%, from about 15% to about 50%, or from about 20% to about 40% of a perfume raw material having boiling point less than or equal to 250° C. and a ClogP greater than 2.5; and
(iii) from about 0 to about 100, from about 1% to about 30%, from about 2% to about 20%, from about 3% to about 15%, or from about 4% to about 10% of a perfume raw material having boiling point greater than 250° C. but less than or equal to 280° C.

23. A fabric enhancer product comprising
(a) a package comprising
(1) a container; and
(2) a closure;
(b) a fabric enhancer pourable at ambient storage temperature and comprising at least one material copourable from the package with the fabric enhancer, wherein the material comprises a fabric enhancer-copourable perfume composition;
(c) a headspace; and
(d) a fabric enhancer-non-copourable perfume composition, provided that at least about 0.10 weight fraction of the perfume of the fabric enhancer-copourable perfume composition is incorporated into a perfume microcapsule; wherein the pH of the fabric enhancer is less than about 7.
